(19) United States
(12) Patent Application Publication
(10) Pub. No.: US 2026/0227100 A1
(43) Pub. Date: Aug. 6, 2026

(54) SOLAR THERMAL ENERGY STORAGE DEVICE

(71) Applicant: King Fahd University of Petroleum and Minerals, Dhahran (SA)

(72) Inventors: Md. Hasan ZAHIR, Dhahran (SA); Mohammad Mozahar HOSSAIN, Dhahran (SA); Kashif IRSHAD, Dhahran (SA); Khalid R. ALHOOSHANI, Dhahran (SA); Amjad ALI, Dhahran (SA)

(73) Assignee: King Fahd University of Petroleum and Minerals, Dhahran (SA)

(21) Appl. No.: 19/045,293

(22) Filed: Feb. 4, 2025

(51) Int. Cl. F24S 60/10; C01F 5/02; C09K 5/06; F28D 20/00; F28D 20/02

(52) U.S. Cl. CPC F24S 60/10; C01F 5/02; C09K 5/063; F28D 20/023; C01P 2002/85; C01P 2004/03; C01P 2004/04; C01P 2004/61; C01P 2006/12; C01P 2006/14; C01P 2006/17; C01P 2006/32; F28D 2020/0017

(57) ABSTRACT

A solar energy storage device that includes a porous support, which includes nanosheets of MgO arranged to form spherical MgO microparticles, and a phase change material. The phase change material is impregnated into the porous support, that has a bimodal pore distribution having a first mode in a region of 5 nanometer (nm) to 10 nm and a second mode in a region of 25 nm to 75 nm. The spherical MgO microparticles have a mean particle size of 2.5 micrometers (μm) to 10 μm and are formed from nanosheets of MgO having a mean thickness of 5 nm to 150 nm.

### STATEMENT OF PRIOR DISCLOSURE BY AN INVENTOR

Aspects of the present disclosure are described in Md. Hasan Zahir, et. al., “A Hierarchical Porous Matrix Containing Hollow MgO Microspheres for Solar Thermal Energy Storage Applications”, Journal of Energy Storage, 2025, 105, 114679, which is incorporated herein by reference in its entirety.

### STATEMENT OF ACKNOWLEDGEMENT

The authors would like to acknowledge the support provided by the Deanship of Scientific Research (DSR) at King Fahd University of Petroleum & Minerals (KFUPM), Dhahran, Saudi Arabia, under Grant No. DF19911049 for this work.

### BACKGROUND

### Technical Field

The present disclosure is directed towards renewable energy storage devices, and more particularly, relates to a solar energy storage device and a method of forming thereof.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Alternate energy resources, specifically, renewable energy resources, are being explored due to severe energy demand and concerns over the effects of fossil fuel use. However, alternative energy generation technologies are severely hampered by limitations in materials. Currently available materials are unable to handle the enormous challenges posed by clean energy technologies due to the low activity of materials and poor stability, as well as due to the shortage of minerals and taxing economical aspects [Mohamed, S. A., et. al., Renewable and Sustainable Energy Reviews, 2017, 70, 1072-1089]. For better and cleaner energy production, recent developments in the formation of porous materials and nanostructured solids are desirable. Production of advanced materials to satisfy the demand for affordable renewable and sustainable energy technologies is desirable. In this regard, development of micrometric and nanometric materials with suitable morphology has been explored [Hu, X., et. al., Adv. Sci. 2023, 10, 2206835; and Gong, S., et. al., Composites Part A: Applied Science and Manufacturing, 2021, 149, 106505].

Advanced materials based on MgO and Mg(OH)₂ have demonstrated desirable properties for a variety of applications in the field of solar energy storage, including as a support medium for phase change materials (PCMs), such as polyethylene glycol (PEG). The material based on the Mg(OH)₂/MgO pair, which is made of readily available, affordable, non-toxic, and non-corrosive components with a large energy storage capacity, is one such material. Dielectric properties and flame resistance of both MgO and Mg(OH)₂ are well-suited for such applications. However, as MgO supports PCMs better than Mg(OH)₂ and is mechanically more stable, they are preferred over Mg(OH)₂ for PCM applications.

Due to its beneficial qualities, such as the suitable melting temperature, appropriate chemical characteristics, low vapor pressure, non-toxicity/non-poisonousness, excellent durability against erosion, and relatively low cost, PEG has been extensively studied as an organic PCM. However, using PEG as a PCM has two significant drawbacks: (i) irregular thermal conductivity and (ii) potential leaks during the liquefication cycle of energy storage. Both these problems can be overcome by encapsulating PEG in a metal or alloy container. However, when PEG is encapsulated in a metal container, supercooling cycles are adversely affected.

MgO has been used in a wide range of applications, including as catalyst supports, additives, refractory materials, and paints. MgO has one of the highest thermal conductivities (48.4 W m⁻¹ K⁻¹) among all oxide materials and is non-toxic. However, only a limited number of studies have been conducted on the synthesis of nano-MgO materials with a high surface area.

Although some researchers claimed to have created mesoporous magnesium oxide using a template-free hydrothermal process, their MgO sample was actually produced by calcining the precursor for two hours at 600° C. in air [Hongmei, C., et. al., Materials Research Bulletin, 2014, 50 307-311; and Mohamed, S. A., et. al., Renewable and Sustainable Energy Reviews, 2017, 70, 1072-1089]. Unfortunately, a simple, straightforward method for mass production of cheap mesoporous MgO materials remains elusive.

In macroporous support materials, capillary forces must be increased to keep the PCM in the matrix throughout the melting cycle. When supported with microporous ZSM-5, SiO₂, and activated carbon (AC), these PCMs have displayed intriguing results. PEG/ZSM-5 composites, for instance, have demonstrated improved thermal reliability as phase change composites [Zhang, L. et. al., Applied Thermal Engineering, 2016, 101, 217-223; and Yang, Y., et. al., Composites Part A: Applied Science and Manufacturing, 2023, 175, 107803]. Although the latent heat capacity of the microporous SiO₂, ZSM-5, and AC support is lower, their higher thermal conductivity more than compensates this shortcoming in terms of the total thermal storage capacity. Nature of the complete apparatus for energy storage using such SS-CPCMs and the dependence of its performance on highly porous supports have not been systematically studied, thus requiring further studies.

Numerous studies have found that mesoporous materials are the best choice to be used as supports to host PCMs owing to their ability to encapsulate and contain liquid PCMs, allowing them to absorb and release latent heat over an extended period. Support materials with a mesoporous pore structure typically lend a high latent heat value to associated ss-PCMs. A porous support may be able to hold a large amount of a liquid PCM if the support has many pores. Formation of a porous support material with hollow particles encircled by two-dimensional nanosheets or air bubbles is a significant advancement. This architecture simultaneously provides two beneficial features to produce a high latent heat. The liquid PCM will first enter the pockets through puff-shaped mesopores and will stay within the safe zone of the structure, which is made up of hollow particles. In the synthesis of materials, pamoic acid (PA) has been found to be a highly effective surfactant, stabilizer, reductant, and a ligand. PA also has the potential to play a key role in determining the shape and size of the nanoparticles [Aziz, M. A., et. al., Journal of Materials Science: Materials in Electronics, 2017, 28, 3226-3233].

Studies on the application of these porous support matrices in energy storage applications are very limited, with drawbacks and limitations such as, potential leakage, poor stability and high cost. Accordingly, one object of the present disclosure is to provide a solar energy storage device and a method of production thereof, that may circumvent the drawbacks of the methods and materials known in the art.

### SUMMARY

According to a first aspect, the present disclosure relates to a solar energy storage device. In some embodiments, the solar energy storage device includes a porous support, which includes nanosheets of MgO arranged to form spherical MgO microparticles, and a phase change material. In some embodiments, the phase change material is impregnated into the porous support. In some embodiments, the porous support has a bimodal pore distribution having a first mode in a region of 5 nanometer (nm) to 10 nm and a second mode in a region of 25 nm to 75 nm. In some embodiments, the spherical MgO microparticles have a mean particle size of 2.5 micrometers (μm) to 10 μm and are formed from nanosheets of MgO having a mean thickness of 5 nm to 150 nm.

In some embodiments, the porous support has a surface area of 150 m²/g to 225 m²/g.

In some embodiments, the porous support has a pore volume of 0.50 cm³/g to 0.65 cm³/g.

In some embodiments, the phase change material is an organic phase change material which is at least one selected from the group consisting of a polyether, a polyolefin, a polyamide, a polycarbonate, a polyester, a petroleum wax, an animal-derived wax, a plant-derived wax, a fatty acid or fatty acid ester, and a sugar alcohol.

In some embodiments, the phase change material is a polyether.

In some embodiments, the phase change material is polyethylene glycol.

In some embodiments, the phase change material is polyethylene glycol has a mean molecular weight of 6000.

In some embodiments, the polyethylene glycol has a mean molecular weight of 6000 in the solar energy storage device has a melting temperature of 55° C. to 62.5° C.

In some embodiments, the solar energy storage device has a thermal conductivity of 0.10 watts per meter-Kelvin (Wm⁻¹K⁻¹) to 2.10 Wm⁻¹K⁻¹.

In some embodiments, the solar energy storage device has a latent heat of melting of 150 Joules per gram (J/g) to 189 J/g.

In some embodiments, the solar energy storage device has a latent heat of fusion of 110 J/g to 140 J/g.

In some embodiments, the solar energy storage device has an energy storage efficiency of greater than 80%.

In some embodiments, the phase change material is present in an amount of 50 percent by weight (wt. %) to 80 wt. % based on a total weight of the energy storage device.

The present disclosure also relates to a method of forming the energy storage device. In some embodiments, the method includes hydrothermally treating a magnesium source and a structure directing agent including an alpha hydroxy carboxylic acid in an aqueous ammonia solution with a pH of 8 to 11 to produce a magnesium hydroxide intermediate. In some embodiments, the method further includes calcining the magnesium hydroxide intermediate at 400° C. to 600° C. for 1 to 4 hours to produce the porous support, and impregnating the support with the phase change material.

In some embodiments, the alpha hydroxy carboxylic acid is an aromatic alpha hydroxy carboxylic acid.

In some embodiments, the aromatic alpha hydroxy carboxylic acid is pamoic acid.

In some embodiments, the magnesium source is magnesium nitrate.

In some embodiments, the magnesium hydroxide intermediate includes nanosheets of magnesium hydroxide arranged to form flower-like microparticles.

In some embodiments, the method of impregnating the support is performed by mixing the porous support with a solution including the phase change material and an organic solvent to form an impregnation mixture and drying the impregnation mixture to form the energy storage device.

In some embodiments, the drying includes heating the impregnation mixture to 60° C. to 100° C. for 12 hour to 36 hour.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a flow chart depicting a method of forming an energy storage device, according to certain embodiments.

FIG. 2A shows a field emission scanning electron microscope (FESEM) image of Mg(OH)₂ possessing a structure with an appearance of a rose flower, according to certain embodiments.

FIG. 2B shows a FESEM image of MgO obtained after heat treatment of Mg(OH)₂, according to certain embodiments.

FIG. 2C shows a FESEM image of MgO obtained after heat treatment of Mg(OH)₂ at a magnification of 1 micrometers (μm), according to certain embodiments.

FIG. 2D shows a FESEM image of MgO obtained after heat treatment of Mg(OH)₂ at a magnification of 500 nanometers (nm), according to certain embodiments.

FIG. 2E shows a FESEM image of MgO obtained after heat treatment of Mg(OH)₂ at a magnification of 200 nm, according to certain embodiments.

FIG. 2F shows an energy dispersive X-ray spectra for the MgO shown in FIG. 2E.

FIG. 3A illustrates an elemental mapping of the magnesium oxide (MgO) composite, depicting the presence of oxygen (O), according to certain embodiments.

FIG. 3B illustrates the elemental mapping of the MgO composite, depicting the presence of chlorine (Cl), according to certain embodiments.

FIG. 3C illustrates the elemental mapping of the MgO composite, depicting the presence of magnesium (Mg), according to certain embodiments.

FIG. 4A shows a transmission electron microscopy (TEM) image of MgO composite, according to certain embodiments.

FIG. 4B shows a high-resolution transmission electron microscopy (HRTEM) of the MgO composite, according to certain embodiments.

FIG. 4C shows a selected area electron diffraction (SAED) image of the MgO composite shown in FIG. 4B.

FIG. 5A is an X-ray photoelectron spectroscopy (XPS) spectrum of MgO, displaying the combined peaks of Mg, O, and C, according to certain embodiments.

FIG. 5B is an XPS spectrum of MgO, depicting the Mg is peak, according to certain embodiments.

FIG. 5C is an XPS spectrum of MgO, depicting the O is peak, according to certain embodiments.

FIG. 5D is an XPS spectrum of MgO, depicting the C is peak, according to certain embodiments.

FIG. 6A is a graph depicting nitrogen (N₂) adsorption/desorption isotherm of MgO, according to certain embodiments.

FIG. 6B shows the pore size distribution of the MgO composite, according to certain embodiments.

FIG. 7 is a graph depicting thermogravimetric analysis (TGA) profiles of polyethylene glycol (PEG), NH₃—PA, and NH₃—PA-PEG, according to certain embodiments.

FIG. 8A shows differential scanning calorimetry (DSC) curves of PEG-6000 PCM samples, depicting a melting and a freezing phase, according to certain embodiments.

FIG. 8B shows DSC curves of MgO/PEG—6000 PCM samples, depicting a melting and a freezing phase, according to certain embodiments.

FIG. 9A is an optical image of metallic iron (Fe) specimen coated with MgO-PEG PCM, according to certain embodiments.

FIG. 9B is an optical image of metallic aluminum (Al) specimen coated with MgO-PEG PCM, according to certain embodiments.

FIG. 9C is an optical image of metallic steel specimen coated with MgO-PEG PCM, according to certain embodiments.

FIG. 9D is an optical image of metallic tin (Sn) specimen coated with MgO-PEG PCM, according to certain embodiments.

FIGS. 9E-9F are optical images of metallic copper (Cu) specimen coated with MgO-PEG PCM, according to certain embodiments.

FIGS. 10A-10C are optical images depicting an effect of heat treatment conducted at 80° C., on the PEG composite, at time intervals of 0 minutes (FIG. 10A), 3 minutes (FIG. 10B), and 10 minutes (FIG. 10C), according to certain embodiments.

FIG. 10D-10F are optical images depicting an effect of heat treatment conducted at 80° C., on the MgO-PEG PCM composite, at time intervals of 0 minutes (FIG. 10D), 3 minutes (FIG. 10E), and 10 minutes (FIG. 10F), according to certain embodiments.

FIG. 11A is a graph depicting light-to-thermal energy conversion curves of PEG 6000 and MgO/PEG composites under solar simulator irradiation of about 120 mW cm⁻², according to certain embodiments.

FIG. 11B is a graph depicting a solar-to-thermal energy conversion curves of PEG 6000 and Ni-BTC/PEG composite under natural sunlight irradiation of about 98 mW cm⁻², according to certain embodiments.

FIG. 12A is a heating temperature curve of Ni-BTC/PEG with a 0.2:0.7 molar ratio compared to PEG, according to certain embodiments.

FIG. 12B is a freezing temperature curve of Ni-BTC/PEG with a 0.2:0.7 molar ratio compared to PEG, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

As used herein, “compound” is intended to refer to a chemical entity, whether as a solid, liquid, or gas, and whether in a crude mixture or isolated and purified.

The present disclosure is intended to include all hydration states of a given compound or formula, unless otherwise noted or when heating a material. For example, Mg(NO₃)₂ includes anhydrous Mg(NO₃)₂, Mg(NO₃)₂·6H₂O, and any other hydrated forms or mixtures. In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium. Isotopes of carbon include ¹³C and ¹⁴C. Isotopes of nitrogen include ¹⁴N and ¹⁵N. Isotopes of oxygen include ¹⁶O, ¹⁷O, and ¹⁸O. Isotopes of magnesium include ²⁴Mg, ²⁵Mg, and ²⁶Mg. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

As used herein, the term “energy storage device” refers to a system or apparatus designed to capture, store, and release energy for later use, typically in the form of thermal, electrical, or chemical energy, depending on its intended application.

As used herein, the term “structure directing agent” refers to a compound or material that influences the formation and organization of a specific structure, typically at the molecular or nanoscale level. The structure directing agent typically has this influence during the synthesis of materials such as zeolites, mesoporous materials, or metal-organic frameworks. A structure directing agent typically functions by guiding the arrangement of building blocks of the material into a desired configuration. A structure directing agent is typically removed from the material following its synthesis or preparation.

As used herein, the term “porous support” refers to a material that contains a network of interconnected pores or voids, which provide a high surface area and are capable of supporting active substances or facilitating the transport and adsorption of molecules. Porous supports are typically used for applications such as catalysis, separation, filtration, or energy storage.

As used herein, the term “impregnating” refers to a process in which a substance (e.g., a solution, liquid, or suspension) is introduced into the pores, surfaces, or structures of a material to embed, coat, or fill it, typically to modify the material's physical, chemical, or functional properties.

As used herein, the term “phase change material” (PCM) refers to a substance that absorbs, stores, and/or releases thermal energy during a phase transition, such as from solid to liquid or liquid to gas, at a specific temperature range. PCMs may be desirable for using this property to regulate temperature or store thermal energy effectively.

As used herein, the term “energy storage efficiency” refers to the ratio of the amount of energy successfully stored in a system to the total energy input, typically expressed as a percentage. This term reflects how effectively a system can capture, retain, and utilize energy without significant losses due to dissipation, conversion inefficiencies, or other factors.

As used herein, the term “latent heat of fusion” refers to the amount of thermal energy required to change a material from a solid phase to a liquid phase (or vice versa) at its melting point, without a change in temperature. It is typically expressed in units of joules per gram (J/g) or kilojoules per kilogram (kJ/kg).

As used herein, the term “latent heat of melting” refers to the amount of thermal energy required to transform a material from a solid state to a liquid state at its melting point, without a change in temperature. This energy is used to overcome the forces holding the solid structure together, rather than raising the material's temperature. It is typically expressed in units of joules per gram (J/g) or kilojoules per kilogram (kJ/kg).

As used herein, the term “thermal conductivity” refers to a material's ability to conduct heat, quantified as the rate at which heat energy is transferred through a material due to a temperature gradient. It is typically expressed in units of watts per meter per kelvin (W/m·K).

Aspects of this disclosure are directed to a solar energy storage device. The solar energy storage device of the present disclosure can efficiently store and release energy, enabling better energy management, sustainability, and enhanced performance in various applications.

According to a first aspect, the present disclosure relates to a solar energy storage device. In some embodiments, the solar energy storage includes a porous support and a phase change material impregnated into the porous support.

In some embodiments, the porous support comprises magnesium oxide (MgO). In some embodiments, the porous support may also include Mg(OH₂). In some embodiments, the porous support is substantially free of Mg(OH)₂. In some embodiments, the porous support may also include one or more secondary porous inorganic materials, such as silica, alumina, titanium dioxide, zirconium dioxide, a zeolite, activated carbon, a mesoporous silica, SBA-15, MCM-41, a porous glass, a porous clay, calcium oxide, calcium carbonate, barium sulfate, cerium oxide, yttrium oxide, niobium oxide, tungsten oxide, tin oxide, zinc oxide, hydroxyapatite, iron oxide, cobalt oxide, nickel oxide, manganese oxide, vanadium oxide, copper oxide, chromium oxide, molybdenum oxide, a silica-alumina composite, and a perovskite oxide. In some embodiments, the porous support is substantially free of secondary porous inorganic materials.

In some embodiments, the magnesium oxide is present in the form of particles. In general, such MgO particles may be microparticles and/or nanoparticles. MgO microparticles can include or be formed from MgO nanoparticles or include nanoscale features formed of MgO. In general, the MgO particles can be any shape known to one of ordinary skill in the art. Examples of suitable shapes the MgO particles may take include spheres, spheroids, lentoids, ovoids, solid polyhedra such as tetrahedra, cubes, octahedra, icosahedra, dodecahedra, hollow polyhedra (also known as nanocages), stellated polyhedra (both regular and irregular, also known as nanostars), triangular prisms (also known as nanotriangles), hollow spherical shells (also known as nanoshells), tubes (also known as nanotubes), nanosheets, nanoplatelets, nanodisks, rods (also known as nanorods), and mixtures thereof. In the case of nanorods, the rod shape may be defined by a ratio of a rod length to a rod width, the ratio being known as the aspect ratio. For MgO particles of the current invention, nanorods should have an aspect ratio less than 1000, preferably less than 750, preferably less than 500, preferably less than 250, preferably less than 100, preferably less than 75, preferably less than 50, preferably less than 25.

In some embodiments, the porous support includes nanosheets of MgO. In some embodiments, the nanosheets of MgO are arranged to form MgO microparticles. In some embodiments, the MgO microparticles are spherical. Such a shape may be referred to as a “petaled microparticle”, “petaled microsphere”, or other similar term. The petal or petaled descriptor may refer to a resemblance between the nanosheets and flower petals when viewed in an electron microscope.

In some embodiments, the MgO particles have uniform shape. Alternatively, the shape may be non-uniform. As used herein, the term “uniform shape” refers to an average consistent shape that differs by no more than 10%, by no more than 5%, by no more than 4%, by no more than 3%, by no more than 2%, by no more than 1% of the distribution of MgO particles having a different shape. As used herein, the term “non-uniform shape” refers to an average consistent shape that differs by more than 10% of the distribution of MgO particles having a different shape. In one embodiment, the shape is uniform and at least 90% of the MgO particles are spherical or substantially circular, and less than 10% are polygonal or non-spherical.

In some embodiments, the MgO particles have a mean particle size of 2.5 to 15 μm, preferably 3 to 12.5 μm, preferably 4 to 10 μm, preferably 4.5 to 9.5 μm, preferably 5 to 9 μm, preferably 5.25 to 8.75 μm, preferably 6.5 to 8.5 μm, preferably 5.75 to 8.25 μm, preferably about 6 to 8 μm. In embodiments where the MgO particles are spherical, the particle size may refer to a particle diameter. In embodiments where the MgO particles are polyhedral or some other non-spherical shape, the particle size may refer to the diameter of a circumsphere. In some embodiments, the particle size refers to a mean distance from a particle surface to particle centroid or center of mass. In alternative embodiments, the particle size refers to a maximum distance from a particle surface to a particle centroid or center of mass. In some embodiments where the MgO particles have an anisotropic shape such as nanorods, the particle size may refer to a length of the nanorod, a width of the nanorod, or an average of the length and width of the nanorod. In some embodiments in which the MgO particles have non-spherical shapes, the particle size refers to the diameter of a sphere having an equivalent volume as the particle. In some embodiments in which the MgO particles have non-spherical shapes, the particle size refers to the diameter of a sphere having an equivalent diffusion coefficient as the particle.

In some embodiments, the nanosheets of MgO have a mean thickness ranging from 5 to 150 nm. For example, the nanosheets of MgO may have a mean thickness of 5 nm, 7.5 nm, 10 nm, 12.5 nm, 15 nm, 17.5 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 105 nm, 110 nm, 115 nm, 120 nm, 125 nm, 130 nm, 135 nm, 140 nm, 145 nm, or 150 nm.

In some embodiments, the MgO particles of the present disclosure are monodisperse, having a coefficient of variation or relative standard deviation, expressed as a percentage and defined as the ratio of the particle size standard deviation (σ) to the particle size mean (μ) multiplied by 100 of less than 25%, preferably less than 10%, preferably less than 8%, preferably less than 6%, preferably less than 5%, preferably less than 4%, preferably less than 3%, preferably less than 2%. In some embodiments, the MgO particles of the present disclosure are monodisperse having a particle size distribution ranging from 80% of the average particle size to 120% of the average particle size, preferably 90-110%, preferably 95-105% of the average particle size. In some embodiments, the MgO particles are not monodisperse. In some embodiments, the nanosheets of MgO have a thickness that is monodisperse. In some embodiments, the nanosheets of MgO have a thickness that is not monodisperse.

In general, the particle size may be determined by any suitable method known to one of ordinary skill in the art. In some embodiments, the particle size is determined by powder X-ray diffraction (PXRD). Using PXRD, the particle size may be determined using the Scherrer equation, which relates the full-width at half-maximum (FWHM) of diffraction peaks to the size of regions comprised of a single crystalline domain (known as crystallites) in the sample. In some embodiments, the crystallite size is the same as the particle size. For accurate particle size measurement by PXRD, the particles should be crystalline, comprise only a single crystal, and lack non-crystalline portions. Typically, the crystallite size underestimates particle size compared to other measures due to factors such as amorphous regions of particles, the inclusion of non-crystalline material on the surface of particles such as bulky surface ligands, and particles which may be composed of multiple crystalline domains. In some embodiments, the particle size is determined by dynamic light scattering (DLS). DLS is a technique which uses the time-dependent fluctuations in light scattered by particles in suspension or solution in a solvent, typically water to measure a size distribution of the particles. Due to the details of the DLS setup, the technique measures a hydrodynamic diameter of the particles, which is the diameter of a sphere with an equivalent diffusion coefficient as the particles. The hydrodynamic diameter may include factors not accounted for by other methods such as non-crystalline material on the surface of particles such as bulky surface ligands, amorphous regions of particles, and surface ligand-solvent interactions. Further, the hydrodynamic diameter may not accurately account for non-spherical particle shapes. DLS does have an advantage of being able to account for or more accurately model solution or suspension behavior of the particles compared to other techniques. In some embodiments, the particle size is determined by electron microscopy techniques such as scanning electron microscopy (SEM) or transmission electron microscopy (TEM).

In some embodiments, the porous support exhibits a bimodal pore size distribution. In some embodiments, the porous support has a pore size distribution having a first modal size of 5 to 10 nm. For example, the first modal size may be 5.0 nm, 5.25 nm, 5.5 nm, 5.75 nm, 6.0 nm, 6.25 nm, 6.5 nm, 6.75 nm, 7.0 nm, 7.25 nm, 7.5 nm, 7.75 nm, 8.0 nm, 8.25 nm, 8.5 nm, 8.75 nm, 9.0 nm, 9.25 nm, 9.5 nm, 9.75 nm, or 10 nm. In some embodiments, the first modal size is about 7.5 nm.

In some embodiments, the porous support has a pore size distribution having a second modal size of 25 to 75 nm. For example, the second modal size may be 25 nm, 27.5 nm, 30 nm, 32.5 nm, 35 nm, 37.5 nm, 40 nm, 42.5 nm, 45 nm, 47.5 nm, 50 nm, 52.5 nm, 55 nm, 57.5 nm, 60 nm, 62.5 nm, 65 nm, 67.5 nm, 70 nm, 72.5 nm, or 75 nm.

In some embodiments, the porous support may have a surface area of 150 to 225 m²/g. For example, the porous support may have a surface area of 150 m²/g, 155 m²/g, 160 m²/g, 165 m²/g, 170 m²/g, 175 m²/g, 180 m²/g, 185 m²/g, 190 m²/g, 195 m²/g, 200 m²/g, 205 m²/g, 210 m²/g, 215 m²/g, 220 m²/g, or 225 m²/g. In some embodiments, the porous support has a surface area of about 184 m²/g.

In some embodiments, the porous support may have a pore volume of 0.50 to 0.65 cm³/g. For example, the porous support may have a pore volume of 0.50 cm³/g, 0.51 cm³/g, 0.52 cm³/g, 0.53 cm³/g, 0.54 cm³/g, 0.55 cm³/g, 0.56 cm³/g, 0.75 cm³/g, 0.58 cm³/g, 0.95 cm³/g, 0.60 cm³/g, 0.61 cm³/g, 0.62 cm³/g, 0.63 cm³/g, 0.64 cm³/g, or 0.65 cm³/g. In some embodiments, the porous support has a pore volume of 0.57 cm³/g.

The phase change material is impregnated into the porous support. In some embodiments, the phase change material is an organic phase change material. In some embodiments, the phase change material is at least one selected from the group consisting of a polyether, a polyolefin, a polyamide, a polycarbonate, a polyester, a petroleum wax, an animal-derived wax, a plant-derived wax, a fatty acid or fatty acid ester, and a sugar alcohol.

Examples of polyolefins include polyethylene, polypropylene, polystyrene, poly(butadiene), poly(isoprene), and poly(vinyl chloride). Examples of polyamides include nylons such as nylon 4, nylon 6, nylon 11, nylon 46, and nylon 66, polyphthalamides such as poly(TPA/hexamethylenediamine) and poly (TPA/methylpentanediamine), polyurea, and poly(amino acids) such as poly(aspartic acid), poly(glutamic acid), polylysine, and polyalanine. Examples of polycarbonates include polypropylene carbonate, allyl diglycol carbonate, and poly(bisphenol A carbonate). Examples of polyesters include polyethylene terephthalate, polylactic acid, polybutyrate, polycaprolactone, polybutylene succinate, and polyglocolide. Examples of petroleum waxes include paraffin, ozokerite, ceresin, and zietrisikite. Examples of animal-derived waxes include beeswax, spermaceti, and lanolin. Examples of plant-derived waxes include bayberry wax, candelilla wax, carnauba wax, castor wax, jojoba wax, rice bran wax, sugarcane wax. Examples of fatty acids include caprylic acid, hexanoic acid, decanoic acid, myristic acid, stearic acid, cerotic acid, elaidic acid, lauric acid, linoleic acid, linolenic acid, mead acid, oleic acid, pinolenic acid, and valeric acid. Fatty acid esters are esters formed from fatty acids. Examples of sugar alcohols include, but are not limited to, ethylene glycol, glycerol, erythritol, threitol, arabitol, xylitol, ribitol, mannitol, sorbitol, galactitol, fucitol, iditol, inositol, volemitol, isomalt, maltitol, lactitol, maltotriitol, maltotetraitol, and polyglycitol. In some embodiments, the organic compound may be a polysaccharide, oligosaccharide, starch, glycogen, pectin, or cellulose.

In some embodiments, the phase change material is a polyether. Examples of polyethers include, but are not limited to, polyethylene oxide, polypropylene oxide, polystyrene oxide, polybutylene oxide, polydioxanone, polyphenyl ether, polyoxymethylene, poly(ethylene oxide)-block-poly(propylene oxide), poly(ethylene glycol)-block-poly(propylene oxide), polycaprolactone, polytetrahydrofuran, poly(ethylene oxide)-poly(propylene oxide)-poly(ethylene oxide), polycyclohexane, polycyclohexane oxide, poly(ethylene glycol) methyl ether, poly(ethylene glycol) ethyl ether, poly(ethylene glycol) propyl ether, poly(ethylene glycol) butyl ether, poly(ethylene glycol) hexyl ether, poly(ethylene glycol) octyl ether, poly(ethylene glycol) decyl ether, poly(ethylene glycol) dodecyl ether, poly(ethylene glycol) tetradecyl ether, poly(ethylene glycol) hexadecyl ether, poly(ethylene glycol) octadecyl ether, poly(ethylene glycol) eicosyl ether, poly(ethylene glycol) docosyl ether, poly(ethylene glycol) tetracosyl ether, poly(ethylene glycol) hexacosyl ether, poly(ethylene glycol) octacosyl ether, poly(ethylene glycol) triethylene glycol, poly(ethylene glycol) tetraethylene glycol, poly(ethylene glycol) pentaethylene glycol, and poly(ethylene glycol) hexaethylene glycol. In a preferred embodiment, the phase change material is polyethylene glycol.

In some embodiments, the polyethylene glycol may have a mean molecular weight of 500 to 10,000 Da. For example, the polyethylene glycol may have a mean molecular weight of 500 Da, 750 Da, 1,000 Da, 1,250 Da, 1,500 Da, 1,750 Da, 2,000 Da, 2,250 Da, 2,500 Da, 2,750 Da, 3,000 Da, 3,250 Da, 3,500 Da, 3,750 Da, 4,000 Da, 4,250 Da, 4,500 Da, 4,750 Da, 5,000 Da, 5,250 Da, 5,500 Da, 5,750 Da, 6,000 Da, 6,250 Da, 6,500 Da, 6,750 Da, 7,000 Da, 7,250 Da, 7,500 Da, 7,750 Da, 8,000 Da, 8,250 Da, 8,500 Da, 8,750 Da, 9,000 Da, 9,250 Da, 9,500 Da, 9,750 Da, or 10,000 Da. In some embodiments, the polyethylene glycol has a mean molecular weight of about 6000 Da.

In some embodiments, the phase change material may present in an amount ranging from 50 to 80 wt. %, based on the total weight of the energy storage device. For example, the phase change material may present in an amount of 50.0 wt. %, 52.5 wt. %, 55 wt. %, 57.5 wt. %, 60 wt. %, 62.5 wt. %, 65 wt. %, 67.5 wt. %, 70 wt. %, 72.5 wt. %, 75 wt. %, 77.5 wt. %, or 80 wt. %. In some embodiments, the phase change material is present in an amount of 60.96 wt. % based on the total weight of the energy storage device.

In some embodiments, the polyethylene glycol may have a melting temperature ranging from 55 to 62.5° C. For example, the polyethylene glycol may have a melting temperature of 55° C., 55.5° C., 56° C., 56.5° C., 57° C., 57.5° C., 58° C., 58.5° C., 59° C., 59.5° C., 60° C., 60.5° C., 61° C., 61.5° C., 62° C., 62.5° C., 63° C., 63.5° C., 64° C., 64.5° C., 65° C., In some embodiments, the polyethylene glycol has a melting temperature of 57.5° C.

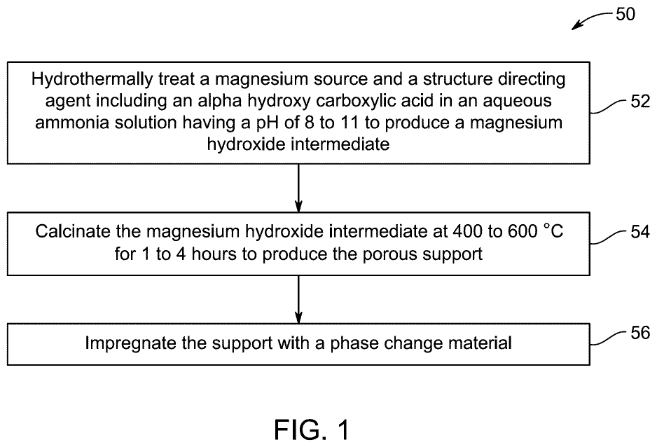

The present disclosure also relates to a method of forming the energy storage device. FIG. 1 illustrates a schematic flow chart of a method 50 of forming the energy storage device The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At step 52, the method 50 includes hydrothermally treating a magnesium source and a structure directing agent including an alpha hydroxy carboxylic acid in an aqueous ammonia solution having a pH of 8 to 11 to produce a magnesium hydroxide intermediate.

In general, the magnesium source can be any suitable source of the Mg²⁺ ion. In some embodiments, the magnesium source may include magnesium chloride, magnesium sulfate, magnesium acetate, magnesium carbonate, magnesium hydroxide, magnesium phosphate, magnesium oxide, magnesium bicarbonate, magnesium sulfide, magnesium aluminate, magnesium borate, magnesium bromide, magnesium fluoride, magnesium iodide, magnesium permanganate, magnesium percarbonate, magnesium potassium sulfate, magnesium nitrate, mixtures thereof, and the like. In some embodiments, the magnesium source is magnesium nitrate.

In some embodiments, the structure directing agent can be a surfactant. As used herein, the term “surfactant” refers to a compound that lowers the surface tension (or interfacial tension) between two liquids, between a liquid and a gas, or between a liquid and a solid. The surfactant may be a nonionic surfactant, an anionic surfactant, a cationic surfactant, a viscoelastic surfactant, or a zwitterionic surfactant. The surfactant may also be a gemini surfactant of any of the types listed previously. The surfactant may serve a role as a water-wetting agent, a defoamer, a foamer, a detergent, a dispersant, or an emulsifier.

A surfactant molecule comprises one or more hydrophilic head units attached to one or more hydrophobic tails. The tail of most surfactants comprises a hydrocarbon chain, which can be branched, linear, or aromatic. Fluorosurfactants have fluorocarbon chains. Siloxane surfactants have siloxane chains. Gemini surfactant molecules comprise two or more hydrophilic heads and two or more hydrophobic tails.

Many surfactants include a polyether chain terminating in a highly polar anionic group. The polyether groups often comprise ethoxylated (polyethylene oxide-like) sequences inserted to increase the hydrophilic character of a surfactant. Alternatively, polypropylene oxides may be inserted to increase the lipophilic character of a surfactant.

Anionic surfactants contain anionic functional groups at their head, such as sulfate, sulfonate, phosphate, and carboxylate. The anionic surfactant may be an alkyl sulfate, an alkyl ether sulfate, an alkyl ester sulfonate, an alpha olefin sulfonate, a linear alkyl benzene sulfonate, a branched alkyl benzene sulfonate, a linear dodecylbenzene sulfonate, a branched dodecylbenzene sulfonate, an alkyl benzene sulfonic acid, a dodecylbenzene sulfonic acid, a sulfosuccinate, a sulfated alcohol, a ethoxylated sulfated alcohol, an alcohol sulfonate, an ethoxylated and propoxylated alcohol sulfonate, an alcohol ether sulfate, an ethoxylated alcohol ether sulfate, a propoxylated alcohol sulfonate, a sulfated nonyl phenol, an ethoxylated and propoxylated sulfated nonyl phenol, a sulfated octyl phenol, an ethoxylated and propoxylated sulfated octyl phenol, a sulfated dodecyl phenol, and an ethoxylated and propoxylated sulfated dodecyl phenol. Other anionic surfactants include ammonium lauryl sulfate, sodium lauryl sulfate (sodium dodecyl sulfate, SLS, or SDS), and related alkyl-ether sulfates sodium laureth sulfate (sodium lauryl ether sulfate or SLES), sodium myreth sulfate, docusate (dioctyl sodium sulfosuccinate), perfluorooctanesulfonate (PFOS), perfluorobutanesulfonate, alkyl-aryl ether phosphates, and alkyl ether phosphates.

Cationic surfactants have cationic functional groups at their head, such as primary and secondary amines. Cationic surfactants include octenidine dihydrochloride; cetrimonium bromide (CTAB), cetylpyridinium chloride (CPC), benzalkonium chloride (BAC), benzethonium chloride (BZT), dimethyldioctadecylammonium chloride, and dioctadecyldimethylammonium bromide (DODAB).

Zwitterionic (amphoteric) surfactants have both cationic and anionic groups attached to the same molecule. Zwitterionic surfactants include CHAPS (3-[(3-cholamidopropyl)dimethylammonio]-1-propanesulfonate), cocamidopropyl hydroxysultaine, ocamidopropyl betaine, phospholipids, and sphingomyelins.

Nonionic surfactants have a polar group that does not have a charge. These include long chain alcohols that exhibit surfactant properties, such as cetyl alcohol, stearyl alcohol, cetostearyl alcohol, oleyl alcohol, and other fatty alcohols. Other long chain alcohols with surfactant properties include polyethylene glycols of various molecular weights, polyethylene glycol alkyl ethers having the formula CH₃—(CH₂)₁₀₋₁₆—(O—C₂H₄)₁₋₂₅—OH, such as octaethylene glycol monododecyl ether and pentaethylene glycol monododecyl ether; polypropylene glycol alkyl ethers having the formula: CH₃—(CH₂)₁₀₋₁₆—(O—C₃H₆)₁₋₂₅—OH; glucoside alkyl ethers having the formula CH₃—(CH₂)₁₀₋₁₆—(O-glucoside)₁₋₃-OH, such as decyl glucoside, lauryl glucoside, octyl glucoside; polyethylene glycol octylphenyl ethers having the formula C₈H₁₇—(C₆H₄)—(O—C₂H₄)₁₋₂₅—OH, such as Triton X-100; polyethylene glycol alkylphenyl ethers having the formula C₉H₁₉—(C₆H₄)—(O—C₂H₄)₁₋₂₅—OH, such as nonoxynol-9; glycerol alkyl esters such as glyceryl laurate; polyoxyethylene glycol sorbitan alkyl esters such as polysorbate, sorbitan alkyl esters, cocamide MEA, cocamide DEA, dodecyldimethylamine oxide, block copolymers of polyethylene glycol and polypropylene glycol, such as poloxamers, and polyethoxylated tallow amine (POEA).

A dendritic surfactant molecule may include at least two lipophilic chains that have been joined at a hydrophilic center and have a branch-like appearance. In each dendritic surfactant, there may be from about 2 lipophilic moieties independently to about 4 lipophilic moieties attached to each hydrophilic group, or up to about 8 lipophilic moieties attached to the hydrophilic group for example. “Independently” as used herein with respect to ranges means that any lower threshold may be combined with any upper threshold. The dendritic surfactant may have better repulsion effect as a stabilizer at an interface and/or better interaction with a polar oil, as compared with other surfactants. Dendritic surfactant molecules are sometimes called “hyperbranched” molecules.

A dendritic extended surfactant is a dendritic surfactant having a non-ionic spacer arm between the hydrophilic group and a lipophilic tail. For example, the non-ionic spacer-arm extension may be the result of polypropoxylation, polyethoxylation, or a combination of the two with the polypropylene oxide next to the tail and polyethylene oxide next to the head. The spacer arm of a dendritic extended surfactant may contain from about 1 independently to about 20 propoxy moieties and/or from about 0 independently to about 20 ethoxy moieties. Alternatively, the spacer arm may contain from about 2 independently up to about 16 propoxy moieties and/or from about 2 independently up to about 8 ethoxy moieties. “Independently” as used herein with respect to ranges means that any lower threshold may be combined with any upper threshold. The spacer arm extensions may also be formed from other moieties including, but not necessarily limited to, glyceryl, butoxy, glucoside, isosorbide, xylitols, and the like. For example, the spacer arm of a dendritic extended surfactant may contain both propoxy and ethoxy moieties. The polypropoxy portion of the spacer arm may be considered lipophilic; however, the spacer arm may also contain a hydrophilic portion to attach the hydrophilic group. The hydrophilic group may generally be a polyethoxy portion having about two or more ethoxy groups. These portions are generally in blocks, rather than being randomly mixed. Further, the spacer arm extension may be a poly-propylene oxide chain.

Another type of surfactant is a viscoelastic surfactant (VES). Conventional surfactant molecules are characterized by having one long hydrocarbon chain per surfactant head-group. In a viscoelastic gelled state these molecules aggregate into worm-like micelles. A viscoelastic gel is a gel that has elastic properties, meaning that the gel at least partially returns to its original form when an applied stress is removed. Typical viscoelastic surfactants include N-erucyl-N,N-bis(2-hydroxyethyl)-N-methyl ammonium chloride and potassium oleate, solutions of which form gels when mixed with inorganic salts such as potassium chloride and/or with organic salts such as sodium salicylate. Previously described surfactants may also be considered viscoelastic surfactants.

Specific examples of structure directing agents include, but are not limited to, pluronic F127, polyvinyl alcohol (PVA), cetyltrimethylammonium bromide (CTAB), P123, tetraethyl orthosilicate (TEOS), octadecyltrimethylammonium bromide (ODTMA), triblock copolymer, sodium dodecyl sulfate (SDS), cationic surfactants, polyethylene glycol (PEG), polypropylene oxide (PPO), hexadecyltrimethylammonium bromide (HTAB), trimethylbenzene, butanol, nonionic surfactants, alkylphenol ethoxylates, polyoxymethylene, dimethyldodecylamine, dodecylamine, stearyltrimethylammonium chloride (STAC), N-dodecylpyridinium chloride, quaternary ammonium salts, triethylamine, triethanolamine, poly(diallyldimethylammonium chloride), 1-dodecanol, sodium lauryl sulfate (SLS), sodium chloride (NaCl), tetra-n-butylammonium bromide, and 1,2-bis(dodecyloxy)-ethane.

In some embodiments, the structure directing agent includes an alpha hydroxy carboxylic acid. Examples of suitable alpha-hydroxy carboxylic acids include, but are not limited to, lactic acid, glycolic acid, citric acid, malic acid, tartaric acid, acetic acid, mandelic acid, hydroxymalic acid, 2-hydroxybutyric acid, 3-hydroxybutyric acid, 4-hydroxybutyric acid, 2-hydroxypropanoic acid, 3-hydroxypropanoic acid, 2-hydroxyglutaric acid, 3-hydroxyglutaric acid, 2-hydroxyvaleric acid, 3-hydroxyvaleric acid, 4-hydroxyvaleric acid, hydroxyphenylacetic acid, 2-hydroxyisovaleric acid, 3-hydroxyisovaleric acid, hydroxyethanesulfonic acid, 2-hydroxyethylmalonic acid, 3-hydroxypropylcarboxylic acid, 4-hydroxybutane-1,2-dicarboxylic acid, 2-hydroxyacetic acid, 3-hydroxy-2,3-dimethylbutanoic acid, 3-hydroxy-2,2-dimethylpropanoic acid, and 2-hydroxyphenylpropionic acid.

In some embodiments, the structure-directing agent is an aromatic alpha hydroxy carboxylic acid. Examples of aromatic alpha-hydroxy carboxylic acids include, but are not limited to, salicylic acid, 2-hydroxybenzoic acid, 3-hydroxybenzoic acid, 4-hydroxybenzoic acid, 2-hydroxy-1-naphthoic acid, 3-hydroxy-1-naphthoic acid, 4-hydroxy-1-naphthoic acid, 2-hydroxycinnamic acid, 3-hydroxycinnamic acid, 4-hydroxycinnamic acid, ferulic acid, caffeic acid, 2-hydroxyphenylacetic acid, 3-hydroxyphenylacetic acid, 4-hydroxyphenylacetic acid, 2-hydroxyphenylpropionic acid, 3-hydroxyphenylpropionic acid, 4-hydroxyphenylpropionic acid, vanillic acid, syringic acid, 2-hydroxy-4-methoxybenzoic acid, 3-hydroxy-4-methoxybenzoic acid, 4-hydroxy-3-methoxybenzoic acid, 2-hydroxy-5-methoxybenzoic acid, 3-hydroxy-5-methoxybenzoic acid, 4-hydroxy-5-methoxybenzoic acid, 2-hydroxy-3,5-dimethoxybenzoic acid, 3-hydroxy-2,5-dimethoxybenzoic acid, and 4-hydroxy-2,5-dimethoxybenzoic acid. In some embodiments, the aromatic alpha hydroxy carboxylic acid is pamoic acid.

In some embodiments, the pH may be maintained in the range of 8 to 11. For example, the pH may be maintained at 8.0, 8.25, 8.5 8.75, 9.0, 9.25, 9.5, 9.75, 10.0, 10.25, 10.5, 10.75, or 11.0. In some embodiments, the pH is maintained at 9.

In some embodiments, hydrothermally treating magnesium nitrate and pamoic acid in an aqueous ammonia solution having a pH of 9 produces an intermediate. In some embodiments, the intermediate is magnesium hydroxide.

In some embodiments, the magnesium hydroxide (Mg(OH)₂) is in the form of particles. In general, such Mg(OH)₂ particles may be microparticles and/or nanoparticles. Mg(OH)₂ microparticles can include or be formed from Mg(OH)₂ nanoparticles or include nanoscale features formed of Mg(OH)₂. In general, the Mg(OH)₂ particles can be any shape known to one of ordinary skill in the art. Examples of suitable shapes the Mg(OH)₂ particles may take include spheres, spheroids, lentoids, ovoids, solid polyhedra such as tetrahedra, cubes, octahedra, icosahedra, dodecahedra, hollow polyhedra (also known as nanocages), stellated polyhedra (both regular and irregular, also known as nanostars), triangular prisms (also known as nanotriangles), hollow spherical shells (also known as nanoshells), tubes (also known as nanotubes), nanosheets, nanoplatelets, nanodisks, rods (also known as nanorods), and mixtures thereof. In the case of nanorods, the rod shape may be defined by a ratio of a rod length to a rod width, the ratio being known as the aspect ratio. For Mg(OH)₂ particles of the current invention, nanorods should have an aspect ratio less than 1000, preferably less than 750, preferably less than 500, preferably less than 250, preferably less than 100, preferably less than 75, preferably less than 50, preferably less than 25.

In some embodiments, the porous support includes nanosheets of Mg(OH)₂. In some embodiments, the nanosheets of Mg(OH)₂ are arranged to form Mg(OH)₂ microparticles. In some embodiments, the Mg(OH)₂ microparticles are spherical. Such a shape may be referred to as a “petaled microparticle”, “petaled microsphere”, or other similar term. The petal or petaled descriptor may refer to a resemblance between the nanosheets and flower petals when viewed in an electron microscope.

In some embodiments, the Mg(OH)₂ particles have uniform shape. Alternatively, the shape may be non-uniform. As used herein, the term “uniform shape” refers to an average consistent shape that differs by no more than 10%, by no more than 5%, by no more than 4%, by no more than 3%, by no more than 2%, by no more than 1% of the distribution of Mg(OH)₂ particles having a different shape. As used herein, the term “non-uniform shape” refers to an average consistent shape that differs by more than 10% of the distribution of Mg(OH)₂ particles having a different shape. In one embodiment, the shape is uniform and at least 90% of the Mg(OH)₂ particles are spherical or substantially circular, and less than 10% are polygonal or non-spherical.

In some embodiments, the Mg(OH)₂ particles have a mean particle size of 2.5 to 15 μm, preferably 3 to 12.5 μm, preferably 4 to 10 μm, preferably 4.5 to 9.5 μm, preferably 5 to 9 μm, preferably 5.25 to 8.75 μm, preferably 6.5 to 8.5 μm, preferably 5.75 to 8.25 μm, preferably about 6 to 8 μm. In embodiments where the Mg(OH)₂ particles are spherical, the particle size may refer to a particle diameter. In embodiments where the Mg(OH)₂ particles are polyhedral or some other non-spherical shape, the particle size may refer to the diameter of a circumsphere. In some embodiments, the particle size refers to a mean distance from a particle surface to particle centroid or center of mass. In alternative embodiments, the particle size refers to a maximum distance from a particle surface to a particle centroid or center of mass. In some embodiments where the Mg(OH)₂ particles have an anisotropic shape such as nanorods, the particle size may refer to a length of the nanorod, a width of the nanorod, or an average of the length and width of the nanorod. In some embodiments in which the Mg(OH)₂ particles have non-spherical shapes, the particle size refers to the diameter of a sphere having an equivalent volume as the particle. In some embodiments in which the Mg(OH)₂ particles have non-spherical shapes, the particle size refers to the diameter of a sphere having an equivalent diffusion coefficient as the particle.

In some embodiments, the nanosheets of Mg(OH)₂ have a mean thickness ranging from 5 to 150 nm. For example, the nanosheets of Mg(OH)₂ may have a mean thickness of 5 nm, 7.5 nm, 10 nm, 12.5 nm, 15 nm, 17.5 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 105 nm, 110 nm, 115 nm, 120 nm, 125 nm, 130 nm, 135 nm, 140 nm, 145 nm, or 150 nm.

In some embodiments, the Mg(OH)₂ particles of the present disclosure are monodisperse, having a coefficient of variation or relative standard deviation, expressed as a percentage and defined as the ratio of the particle size standard deviation (σ) to the particle size mean (μ) multiplied by 100 of less than 25%, preferably less than 10%, preferably less than 8%, preferably less than 6%, preferably less than 5%, preferably less than 4%, preferably less than 3%, preferably less than 2%. In some embodiments, the Mg(OH)₂ particles of the present disclosure are monodisperse having a particle size distribution ranging from 80% of the average particle size to 120% of the average particle size, preferably 90-110%, preferably 95-105% of the average particle size. In some embodiments, the Mg(OH)₂ particles are not monodisperse. In some embodiments, the nanosheets of Mg(OH)₂ have a thickness that is monodisperse. In some embodiments, the nanosheets of Mg(OH)₂ have a thickness that is not monodisperse.

In some embodiments, the Mg(OH)₂ intermediate is in the form of particles that are substantially similar to the MgO particles as described above.

At step 54, the method 50 includes calcining the magnesium hydroxide intermediate at 400 to 600° C. for 1 to 4 hours to produce the porous support.

In some embodiments, the magnesium hydroxide intermediate may be calcined at a temperature range of 400 to 600° C. For example, the magnesium hydroxide intermediate can be calcined at 400° C., 425° C., 450° C., 475° C., 500° C., 525° C., 550° C., 575° C., or 600° C. In some embodiments, the magnesium hydroxide intermediate is calcined at 500° C.

In some embodiments, the magnesium hydroxide intermediate may be calcined for a duration of 1 to 4 hours. For example, the magnesium hydroxide intermediate may be calcined for 1.0 hours, 1.25 hours, 1.5 hours, 1.75 hours, 2.0 hours, 2.25 hours, 2.5 hours, 2.75 hours, 3.0 hours, 3.25, 3.5 hours, 3.75 hours, or 4.0 hours. In some embodiments, the magnesium hydroxide intermediate is calcined for 2 hours.

At step 56, the method 50 includes impregnating the support with the phase change material. The impregnating may be performed by mixing the porous support with a solution including the phase change material and an organic solvent to form an impregnation mixture and drying the impregnation mixture to form the energy storage device.

In some embodiments, the organic solvent may include but is not limited to methanol, ethanol, isopropanol, butanol, acetone, dimethylformamide (DMF), dimethyl sulfoxide (DMSO), tetrahydrofuran (THF), chloroform, dichloromethane, toluene, xylene, hexane, heptane, cyclohexane, ethyl acetate, methyl acetate, benzene, anisole, pyridine, nitromethane, formamide, propylene carbonate, ethylene glycol, diethyl ether, petroleum ether, trichloroethylene, butyl acetate, diisopropyl ether, and methyl isobutyl ketone (MIBK).

In some embodiments, the impregnation mixture does not include an organic solvent.

In some embodiments, the drying process includes heating the impregnation mixture ranging from 60 to 100° C. For example, the heating can be performed at 60° C., 65° C., 70° C., 75° C., 80° C., 85° C., 90° C., 95° C., or 100° C. In some embodiments, the drying process includes heating the impregnation mixture ranging from 12 to 36 hours. For example, the heating can be performed for 12 hours, 14 hours, 16 hours, 18 hours, 20 hours, 22 hours, 24 hours, 26 hours, 28 hours, 30 hours, 32 hours, 34 hours, or 36 hours.

In some embodiments, the solar energy storage device may have a thermal conductivity ranging from 0.10 to 2.10 Wm⁻¹K⁻¹. For example, the solar energy storage device may have a thermal conductivity of 0.10 Wm⁻¹K⁻¹, 0.15 Wm⁻¹K⁻¹, 0.20 Wm⁻¹K⁻¹, 0.25 Wm⁻¹K⁻¹, 0.30 Wm⁻¹K⁻¹, 0.35 Wm⁻¹K⁻¹, 0.40 Wm⁻¹K⁻¹, 0.45 Wm⁻¹K⁻¹, 0.50 Wm⁻¹K⁻¹, 0.55 Wm⁻¹K⁻¹, 0.60 Wm⁻¹K⁻¹, 0.65 Wm⁻¹K⁻¹, 0.70 Wm⁻¹K⁻¹, 0.75 Wm⁻¹K⁻¹, 0.80 Wm⁻¹K⁻¹, 0.85 Wm⁻¹K⁻¹, 0.90 Wm⁻¹K⁻¹, 1.00 Wm⁻¹K⁻¹, 1.05 Wm⁻¹K⁻¹, 1.10 Wm⁻¹K⁻¹, 1.15 Wm⁻¹K⁻¹, 1.20 Wm⁻¹K⁻¹, 1.25 Wm⁻¹K⁻¹, 1.30 Wm¹K⁻¹, 1.35 Wm⁻¹K⁻¹, 1.40 Wm⁻¹K⁻¹, 1.45 Wm⁻¹K⁻¹, 1.50 Wm⁻¹K⁻¹, 1.55 Wm⁻¹K⁻¹, 1.60 Wm⁻¹K⁻¹, 1.65 Wm⁻¹K⁻¹, 1.70 Wm⁻¹K⁻¹, 1.75 Wm⁻¹K⁻¹, 1.80 Wm⁻¹K⁻¹, 1.85 Wm⁻¹K⁻¹, 1.90 Wm⁻¹K⁻¹, 1.95 Wm⁻¹K⁻¹, 2.00 Wm⁻¹K⁻¹, 2.05 Wm⁻¹K⁻¹, or 2.10 Wm⁻¹K⁻¹. In some embodiments, the solar energy storage device has a thermal conductivity of 0.74 Wm⁻¹K⁻¹.

In some embodiments, the solar energy storage device may have a latent heat of melting ranging from 150 to 189 J/g. For example, the solar energy storage device may have a latent heat of melting of 150 J/g, 152.5 J/g, 155 J/g, 157.5 J/g, 160 J/g, 162.5 J/g, 165 J/g, 167.5 J/g, 170 J/g, 172.5 J/g, 175 J/g, 177.5 J/g, 180 J/g, 182.5 J/g, 185 J/g, 187.5 J/g, or 189 J/g. In some embodiments, the solar energy storage device has a latent heat of melting of 173 J/g.

In some embodiment, the solar energy storage device may have a latent heat of fusion ranging from 110 to 140 J/g. For example, the solar energy storage device may have a latent heat of fusion of 110 J/g, 112.5 J/g, 115 J/g, 117.5 J/g, 120 J/g, 122.5 J/g, 125 J/g, 127.5 J/g, 130 J/g, 132.5 J/g, 135 J/g, 137.5 J/g, or 140 J/g. In some embodiments, the solar energy storage device has a latent heat of fusion of 123.4 J/g.

In some embodiments, the solar energy storage device may achieve an energy storage efficiency greater than 70%. For example, the solar energy storage device may achieve an energy storage efficiency greater than 70%, greater than 72%, greater than 74%, greater than 76%, greater than 78%, greater than 80%, greater than 82%, greater than 84%, greater than 86%, greater than 88%, greater than 90%, greater than 92%, greater than 94%, greater than 96%, or greater than 98%. In some embodiments, the solar energy storage device achieves an energy storage efficiency of 82%.

### EXAMPLES

The following examples demonstrate a solar energy storage device. The examples are provided solely for illustration and are not to be construed as limitations of the present disclosure, as many variations thereof are possible without departing from the spirit and scope of the present disclosure.

### Example 1: X-Ray Diffraction (XRD) and Fourier Transform Infrared (FTIR) Analysis

XRD patterns of as-synthesized powders of MgO prepared using NH₃, NH₃—PA precipitating agents, and XRD pattern of powder synthesized using NH₃—PA calcined at 500° C. for 2 h, were evaluated and analyzed. Further, FTIR spectra of the aforementioned compounds were obtained and analyzed.

### Example 2: Microstructures

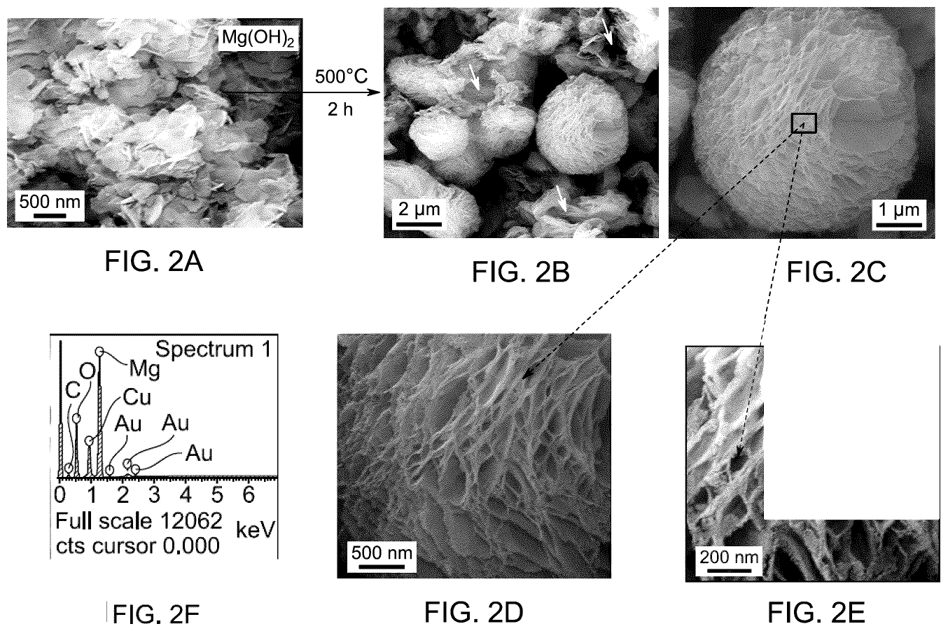

FIGS. 2A-2E depicted field emission scanning electron microscopy (FESEM) images showed the hierarchical porous structures of two-dimensional (2D) nanosheets made up of 6 micrometer (μm) to 8 μm microspheres of MgO powders. In order to produce the MgO microspheres, the precursor Mg(OH)₂ was calcined for two hours at 500° C. in air. The FESEM analysis results of the MgO particles are shown in FIGS. 2B, 2C, 2D, and 2E, with enlarged views provided in FIGS. 2C, 2D, and 2E. During the thermal processing, the loss of volatile gases such as H₂O and CO₂ led to the formation of MgO microspheres with an enhanced pore structure. The structure was more developed than that of zinc hydroxide carbonate (ZHC) microspheres, which were produced using the same hydrothermal process followed by calcination [You, S., et. al., Nanomaterials. 9 (2015) 680306, incorporated herein by reference in its entirety]. FIGS. 2D and 2E depicted the formation of petaloid microspheres featuring a house-of-cards structure on their surfaces. FESEM analysis of the composite revealed that a substantial amount of PEG was uniformly distributed within the pores of the magnesium oxide. Moreover, the dispersion was stabilized by capillary forces and surface tension, ensuring uniform distribution across the surfaces.

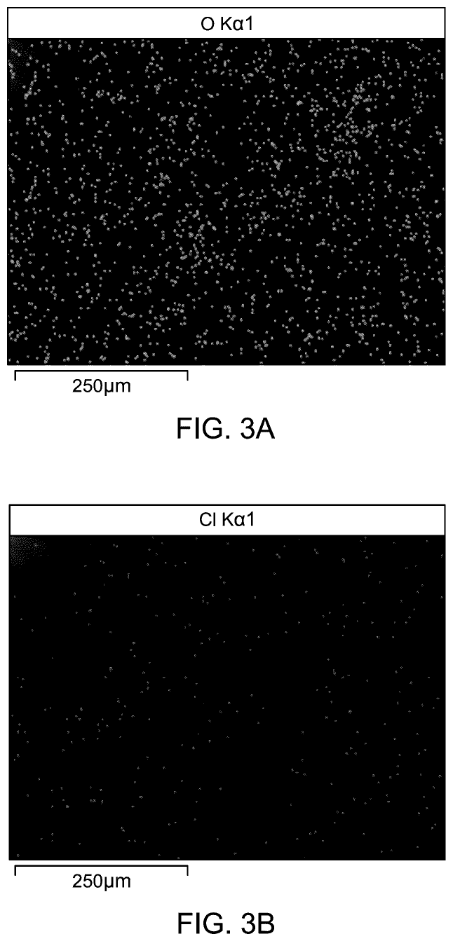

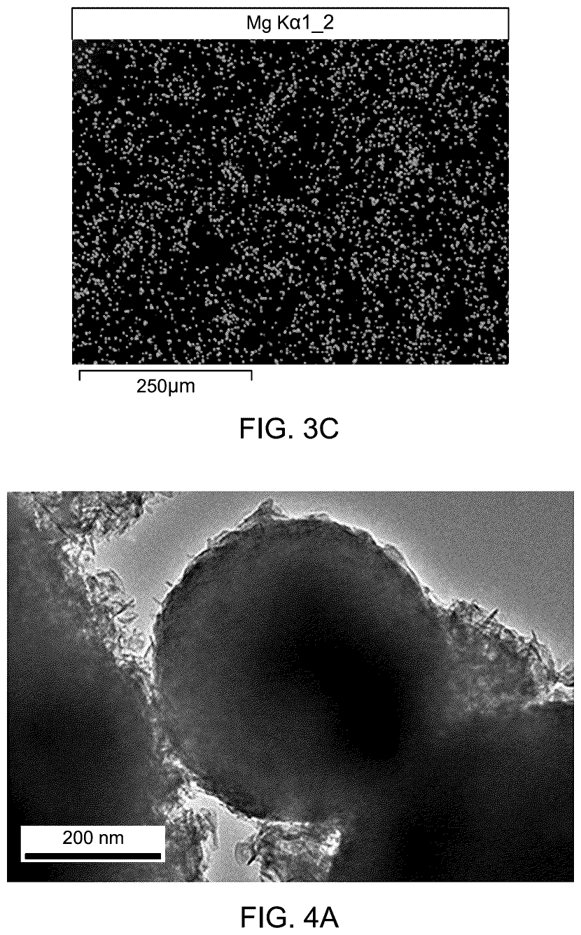

The energy dispersive X-ray (EDX) spectra is shown in FIG. 2E depicting the pure magnesium oxide including Mg, O, and gold (Au), which appeared due to the coating used for FESEM analysis. Elemental mapping of MgO is shown in FIGS. 3A-3C, illustrating the pure magnesium oxide including Mg, O, C, and Au, with the Au attributed to the SEM coating. The mapping results implied that the elements were evenly distributed across the sample.

The pamoic acid (PA) may prevent the aggregation of hexagonal Mg(OH)₂ nanoflakes and regulate the rate of growth. The formation of “PA-Mg²⁺ pairs” may be responsible for crystal formation in the synthesized microspheres. Prior to hydrothermal treatment, PA may coordinate with Mg²⁺ ions in Mg(NO₃)₂ via oxygen donors, resulted in the formation of “PA-Mg²⁺ pairs” through complex formation. The “PA-Mg²⁺ pairs” may be combined through stirring and aging. The process may result in a structure where PA chains twisted and coiled around each other, forming puffy nanosheets composed of microspheres.

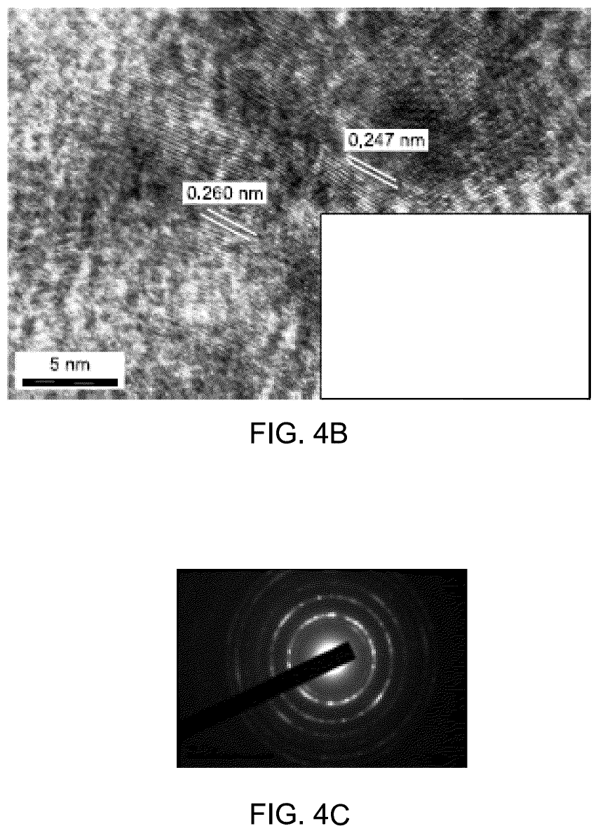

The transmission electron microscopy (TEM) images of the porous MgO composite, are provided in FIG. 4A, which show the development of petaloid microspheres with a house-of-cards pattern on its exterior. The framework spacings of 0.260 nm and 0.247 nm, obtained from the high resolution transmission electron microscopy (HRTEM) image of porous MgO in FIG. 4B, corresponded well to the (002) and (101) planes of MgO, respectively.

### Example 3: X-Ray Photoelectron Spectroscopy (XPS)

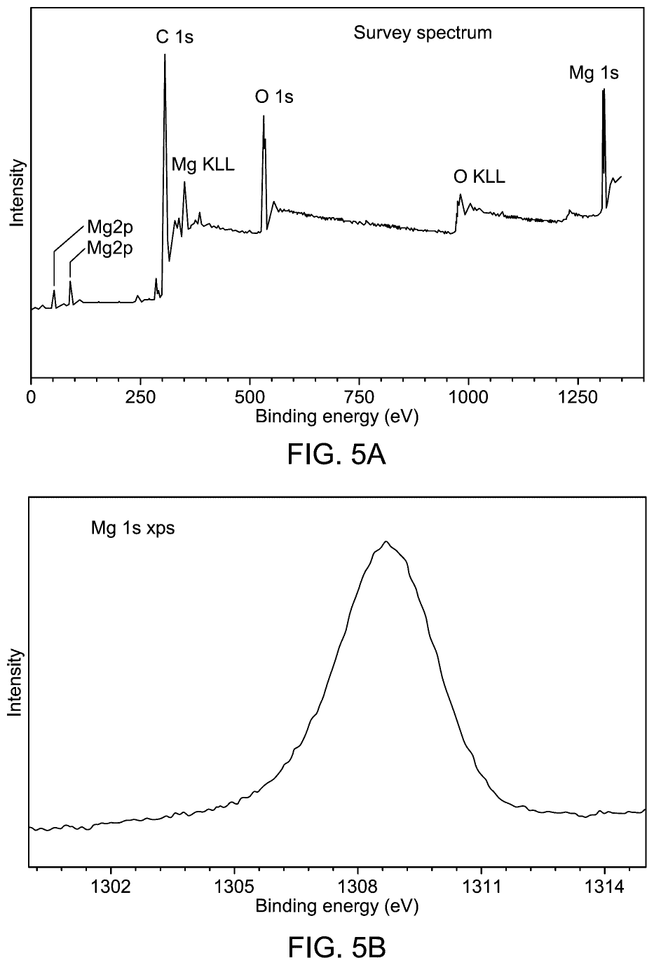

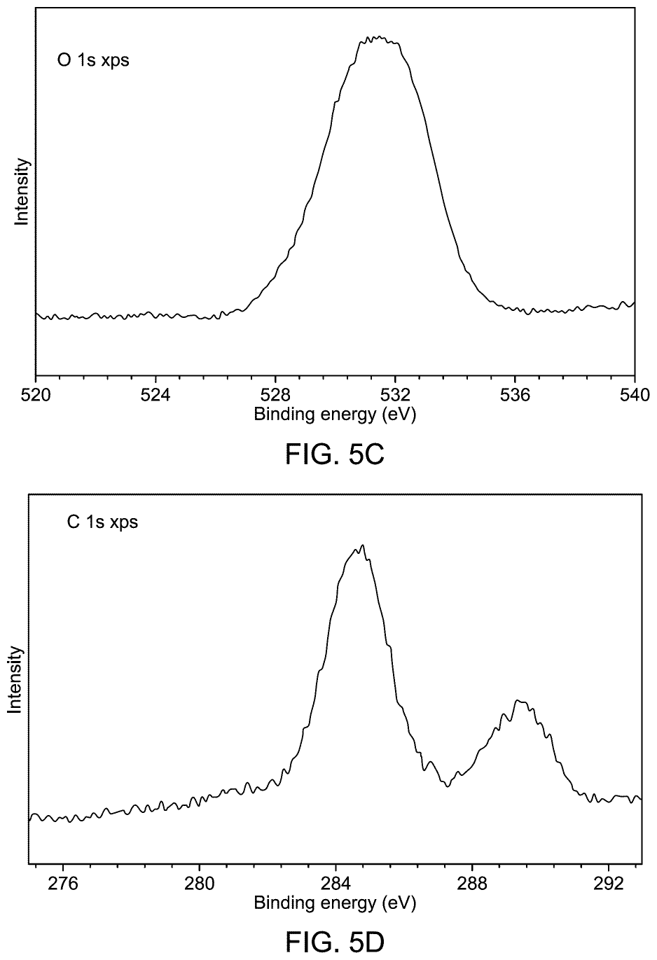

The XPS spectra of the MgO particles shown in FIGS. 5A-5D showed the surface composition and the representative peaks of Mg, O, and C. The XPS peak at 1307 eV in FIG. 5B corresponded to Mg Is, while FIG. 5D showed two peaks associated with carbon species that appeared in the C is spectrum. Carbon-oxygen bonds were responsible for the CII-type peak, while the broad XPS peak at 532.5 eV was due to the O Is.

In the present disclosure, three component peaks were identified in the Mg is core level spectrum. It may be noted that the presence of an OH group on the surface of PCM may influence the reduction of the supercooling effect [Agnieszka, A., et. al., Powder Technol. 2017, 319, 373-407, incorporated herein by reference in its entirety]. Mg and MgO were responsible for the other two component peaks. The O is component at high binding energy was attributed to oxygen species, similar to those in water, that became adsorbed onto Mg as a result of air exposure and the hydrothermal process.

### Example 4: Pore Size Distribution

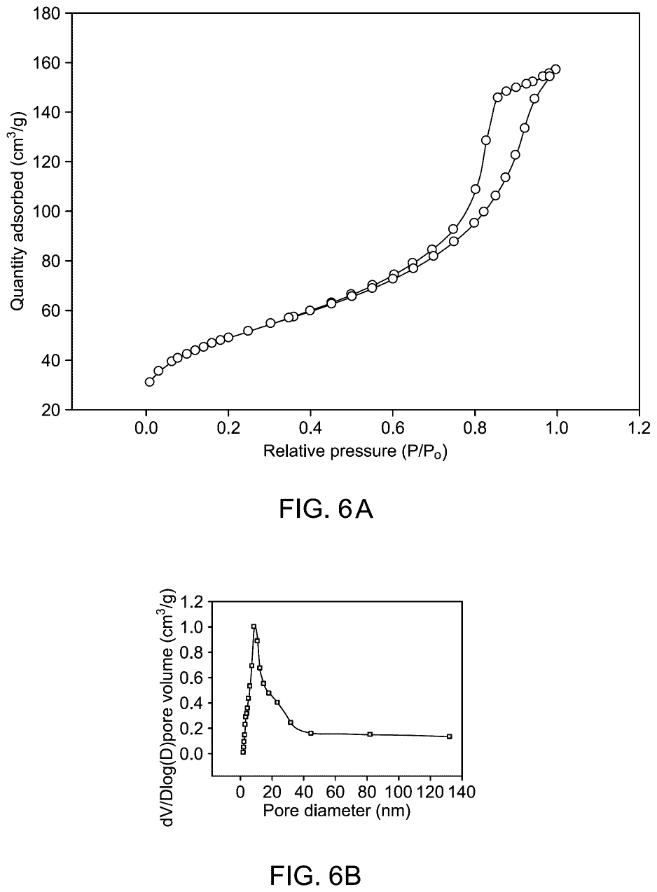

Type H3 mesoporous loop was distinguished by two characteristics involving the mesoporous material and the porous network of the mesoporous material with both mesopores and macropores [Zahir, M. H., et. al., Nanomaterials. 9 (2019) 1773, incorporated herein by reference in its entirety]. Characteristics of the assumed template had an influence on the shape and porosity of the synthesized matrix. However, synthesis of the SBA-15 and CMK-3 templates was complex with low yield of mesoporous material [Jan, R., et. al., Chemistry Materials. 18 (2006), incorporated herein by reference in its entirety]. Mesoporous MgO materials obtained using hard templating techniques exhibit significantly increased surface area, a larger pore volume, and a narrower pore size distribution. The pores of MgO material obtained with the addition of PA, were organized, consistent, and had a narrow distribution. In addition, most of the published literature lacks crucial data required for the preparation of PCMs, specifically the pore volume of their support. The PCM incorporated into the porous support was largely responsible for the high latent heat of the ss-CPCM, as shown in FIG. 6A. The MgO sample included a mesoporous structure indicated by the Type IV isotherm with a hysteresis loop. The presence of mesopores was demonstrated by the correlation between hysteresis and the capillary condensation that filled and emptied the mesopores. MgO exhibited a surface area of 184 m²/g and a pore volume of 0.57 cm³/g, along with two relatively large pore size distributions at 7.5 nm and 30 nm to 50 nm, as shown in FIG. 6B. The petaloid-type microspheres with their multilayered MgO/PEG structure likely provides a substantial surface area for PEG to achieve shape stability both before and after phase transition. Mesoporous nature of MgO was thought to facilitate organic PEG adsorption.

### Example 5: Thermogravimetric Analysis (TGA)

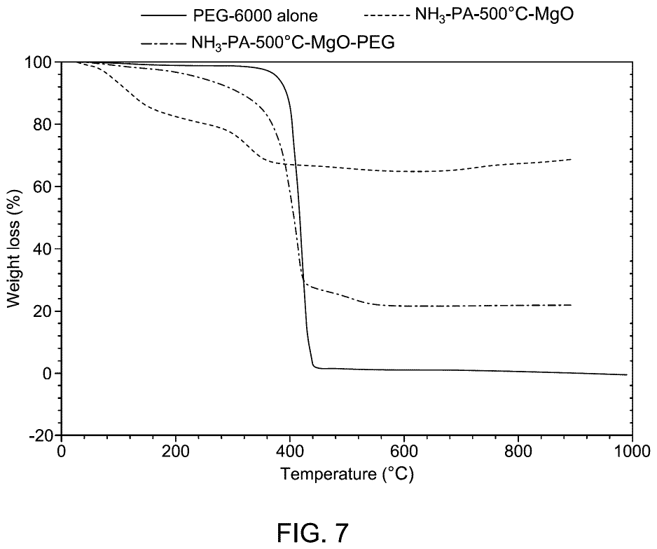

The TGA curves of pure PEG, as-produced MgO, and the PEG/MgO compound obtained under an N₂ flow, are shown in FIG. 7. The TGA decomposition process was performed at a heating rate of 5° C. per minute. The samples lost an amount of weight in the range of 280° C. to 450° C. temperature. Pure PEG-6000 began to melt at 440° C. and completely decomposed when the temperature reached 500° C. At this temperature, PEG-6000 lost about 95.97% of weight in a nitrogen environment, consistent with the pyrolysis of functional groups of PEG. The melting and/or decomposition temperatures of PEG in the composite were about 20% higher than those of pure PEG, indicating strong interactions between PEG and the MgO matrix. The weight of MgO began to decrease as soon as heating started, losing nearly 24% at a temperature of about 650° C. MgO exhibited two main weight-loss zones, an initial 12% weight loss up to 200° C. due to the removal of absorbed water and hydroxide groups, and a second stage in the range of 370° C. to 800° C. due to the oxidation of remaining organic molecules and the release of chemically bound H₂O. As shown in FIG. 7, the PEG/MgO PCMs displayed strong thermal stability below 300° C., with both PEG/MgO and pure PEG weight loss curves showing a single step. Thermal stability is critical for practical heat storage applications. The results showed that the porous MgO support acted as a protective barrier, enhancing the thermal stability of PEG.

### Example 6: Thermal Conductivity of MgO/PEG

Table 1 illustrates that the thermal conductivity of MgO/PEG was approximately 58% higher than that of pure PEG. Enhanced thermal conductivity is very useful for increasing heat energy storage and release. The higher conductivity may accelerate the charging and discharging rates when the materials were used to capture solar energy and recover waste heat, potentially reducing time and improving efficiency.

TABLE 1
Thermal conductivity of PEG-6000 alone and MgO/PEG PCM.

| Sample | Conductivity (Wm⁻¹K⁻¹) |
|---|---|
| PEG-6000 | 0.2124 |
| MgO/PEG | 0.7423 |

The measured maximal deviations for conductivity values were ±0.05 Wm⁻¹k⁻¹ considering the averages of five measurements.

As can be seen from Table 1, the thermal conductivity of MgO/PEG was about 0.74 W/W m⁻¹ K⁻¹. The higher value may be due to the presence of MgO and the formation of rigid pores. The SiO₂/PEG and ZSM/PEG systems exhibited similar behavior. Reported results indicated that the pore structure of SiO₂ formed a thermally conducting network, thereby increasing the thermal conductivity of PEG [Aziz, M. A., et. al., Journal of Materials Science: Materials in Electronics. 28 (2017) 3226-3233, incorporated herein by reference in its entirety]. ZSM-5 increased the thermal conductivity of PEG/ZSM-5 due to the formation of thermally conductive pathways [Chaoen, L., et. al., Renewable Energy. 121 (2018) 45-52; and Chongyun, W., et. al., Solar Energy Materials and Solar Cells. 105 (2012) 21-26, each of which is incorporated herein by reference in its entirety.].

### Example 7: Thermal Storage Behavior by Differential Scanning Calorimetry (DSC)

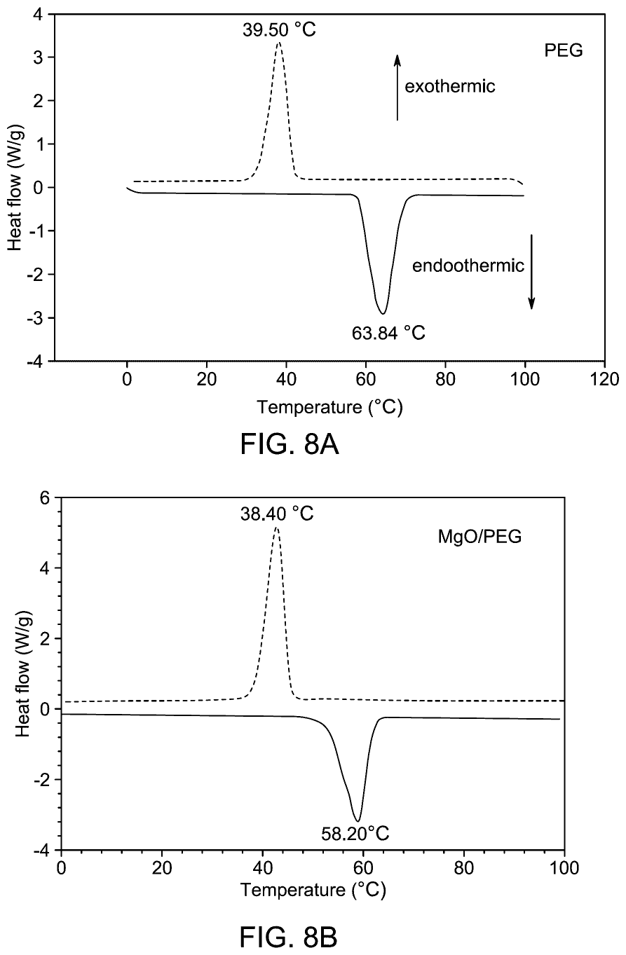

The DSC curves for melting and freezing are shown in FIGS. 8A-8B for PEG and MgO/PEG, respectively. The enthalpies of PEG and the composite system were estimated by totaling the areas beneath the DSC profiles for the freezing and melting cycles. PEG had a melting enthalpy of 189.6 joules per gram (J/g) and a freezing enthalpy of 170.1 J/g. The composite system displayed an incomplete loss of both the latent heat of freezing and melting, due to the existence of the matrix.

The thermal storage capability of the MgO/PEG composite demonstrated that nearly all PEG molecules efficiently released or stored energy during phase transitions. As a result, the latent heat value was 173.0 J/g higher as compared to other Mg(OH)₂-based samples [Mohamed, S. A., et. al., Renew. Sustain. Energy Rev. 2016, 70, 1078-1089, incorporated herein by reference in its entirety]. The obtained value was higher than the values known in the art, as listed in Table 2.

TABLE 2
Thermal storage properties determined by DSC of PEG-
6000, MgO/PEG, and Mg(OH)₂/PEG PCMs, in comparison
with multiple PEG composite PCMs known in the art.

| | T_{f} | Tₘ | ΔH_{f} | ΔHₘ | | | | |
|---|---|---|---|---|---|---|---|---|
| Sample | (° C.) | (° C.) | (J/g) | (J/g) | ΔTₛ | R(%) | E(%) | φ (%) |
| *PEG-6000 | 39.5 | 63.84 | 170.1 | 189.6 | 24.34 | — | | |
| *MgO/PEG-6000 | 38.4 | 58.2 | 123.4 | 173 | 19.80 | 91.24 | 82.4 | 90.31 |
| *Mg(OH)₂/PEG- | 37.97 | 57.84 | 118.5 | 134.9 | 19.88 | 71.15 | 70.45 | 92.01 |
| 6000 | | | | | | | | |
| ¹MgO/PEG1000 | 18.30 | 34.4 | — | 61.62 | 16.10 | 64.6 | | |
| ²SiO₂/PEG-10,000 | — | 61.61 | — | 162.9 | — | — | | |
| ³SiO₂-β-AIN/ | 45.13 | 60.41 | 161.4 | 132.9 | 15.28 | — | | |
| PEG-1000 | | | | | | | | |

(The entries with asterisk *represent the present disclosure)
¹= Mohamed, S. A., et. al., Renew. Sustain. Energy Rev. 2016, 70, 1078-1089.
²= Mohamed, S. A., et. al., Renew. Sustain. Energy Rev. 2016, 70, 1078-1089.
³= M. H. Zahir, et. al., Nanomaterials. 9 (2019) 1773

The SEM images of the composite revealed that an amount of PEG was evenly distributed on the surfaces throughout the porous MgO structure, held in place by surface tension and capillary forces. The high energy storage efficiency of the evaluated PCMs, with a peak value of 96.48%, was a vital assessment parameter. The efficiencies of the materials tested in the present disclosure are higher than those known in the art, as listed in Table 2. PEG and MgO/PEG had solidification and melting temperatures that differed by 29.5° C. and 19.89° C., respectively. The obtained XRD profiles indicated that the height of peaks in the MgO/PEG pattern was lower than that of PEG. The results suggested that the porous structure of MgO/PEG retained a higher PEG concentration [Hongmei, C., et. al., Materials Research Bulletin. 50 (2014) 307-311, incorporated herein by reference in its entirety]. The latent melting and freezing temperatures of the MgO/PEG were consistent with this conclusion. Furthermore, cavities were not present after the freezing process, resulting in the stability of the MgO/PEG PCM, after about 200 heat cycles.

In the present disclosure, PA acted as a stabilizer, surfactant, reductant, and a ligand. PA was employed to control the size and shape of the nanoparticles. The capping and decreasing effects of PA stabilized the nano-intermediate products. The presence of a linear polymer chain (CH₂—CH₂—O)ₙ in PEG with hydroxyl groups at both ends offered a high latent heat value to PEG encapsulated in MgO, with PA played a role.

The SEM images of the PEG/MgO composite showed that the pores were filled with PEG, which appeared to be evenly distributed across the surface of the MgO porous structure, guided by surface tension and capillary forces. Furthermore, PEG/MgO composite sample exhibited the lowest supercooling value among all the samples tested. The low supercooling value was likely due to the high surface area of MgO and strong polar OH—OH surface interactions, which helped reduce supercooling effects.

The MgO/PEG composite produces a high impregnation ratio of 60.96% and an efficiency of 58.22%. In addition, the thermal storage capacity exceeds 98.85%, indicating that virtually all PEG molecule chains may store and release heat efficiently via phase changes. MgO produced in the present disclosure was a mesoporous substance that supports PEG while enhancing the mechanical strength of the composite. Hence, the solid-state (ss)-CPCM maintained its structure and prevents the leakage of liquid PEG. The surface of the matrix of the supported PCMs was impermeable to the leakage of molten PEG. The microporous structure and granularity of MgO particles enhanced the capture and retention of PEG.

The parameters presented in Table 1 were calculated according to equations 1-4 [Chongyun, W., et. al., Solar Energy Materials and Solar Cells. 105 (2012) 21-26; and Xinpeng Hu, et. al., 14-Chem. Eng. J. 2023, 471: 144720, each of which is incorporated herein by reference in its entirety].

$$R = \frac{Δ {H}_{m , com}}{Δ {H}_{m , PEG}} \times 100 \% \qquad ( 1 )$$

$$E = \frac{Δ {H}_{m , com} + Δ {H}_{f , com}}{Δ {H}_{m , PEG} + Δ {H}_{f , PEG}} \times 100 \% \qquad ( 2 )$$

$$φ = \frac{\frac{Δ {H}_{m , com} + Δ {H}_{f , com}}{R}}{Δ {H}_{m , PEG} + Δ {H}_{f , PEG}} \times 100 \% \qquad ( 3 )$$

$${E}_{eff} = \frac{Δ {H}_{m , com}}{{x}_{PEG}} \qquad ( 4 )$$

where, “ΔHₘ” denoted the latent heat, “Tₘ” referred to the melting temperature, “ΔH_{f}” signified the latent heat of cooling, “T_{f}” indicated the freezing point, “R” represented the impregnation ratio, “φ” denoted the energy storage capacity, “ΔT” indicated the temperature variation caused by supercooling, “E” represented the energy storage efficiency, “E_{ef}” signified the efficient energy per unit mass of PEG, and X_{PCM} corresponded to the polymer weight fraction in the PCM.

As shown in FIG. 8B, MgO/PEG had a low supercooling value and a high latent heat value. The high surface area of MgO and the strong polar OH—OH bonds on the surface may have suppressed the effect of supercooling, leading to these results. As shown in the SEM image, PEG filled the MgO pores, and a sufficient amount of PEG may be encapsulated in the MgO pores based on the proportions used to form the composite. Polyethylene glycol was retained by porous supporting materials due to their surface tension and capillary forces.

The mechanical strength of the PEG/MgO composite may be attributed to the porous MgO-PA-like structure, which retained melted polyethylene glycol without allowing it to leach and maintained its shape when in the solid state. The PEG/MgO PCM composite did not allow melted PEG to leak up to the employed mass ratio, even when the melting-freezing DSC cycling curves were repeated 200 times.

### Example 8: Compatibility Test

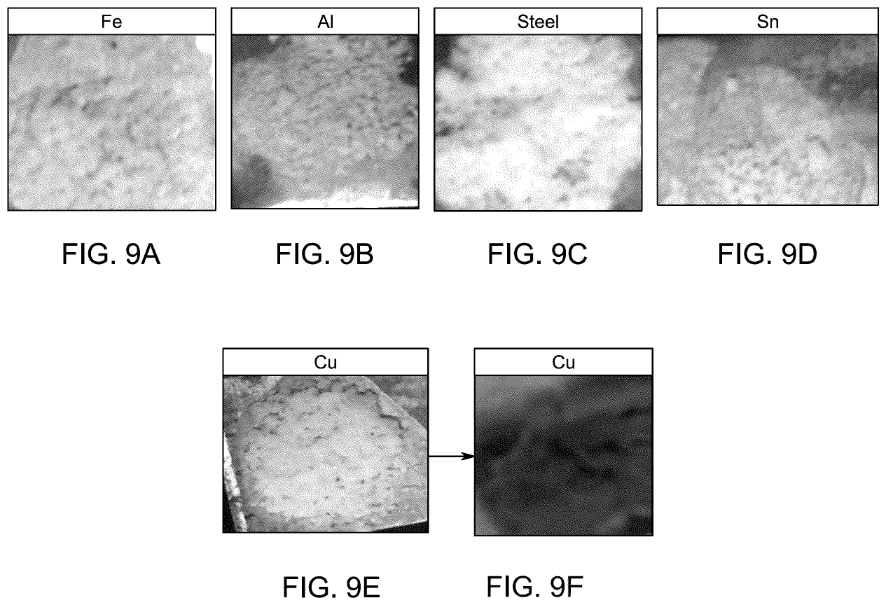

The compatibility of the synthesized PCM with various materials used for manufacturing containers was evaluated, as it required appropriate storage for future use. To assess this, sheets of iron, aluminum, copper, tin, stainless steel, and those shown in FIGS. 9A-9E were exposed to the atmosphere while in contact with the PCM. The MgO-PEG specimens were stored in Khobar, Saudi Arabia, under ambient conditions from May to September. During this period, the temperature ranged from a maximum of 50° C. to a minimum of approximately 15° C. The results confirmed that the metal samples were compatible with the PCM.

In addition, the weight of the metal sheets showed that they did not lose weight based on measurements taken before and after exposure. In general, MgO-PEG may be used to create containers for the long-term storage of prepared PCM on surfaces made of stainless steel, galvanized iron, aluminum, and tin. However, under the same conditions, only the copper-coated sample changed in weight and color, indicating that a copper container was not suitable for long-term storage.

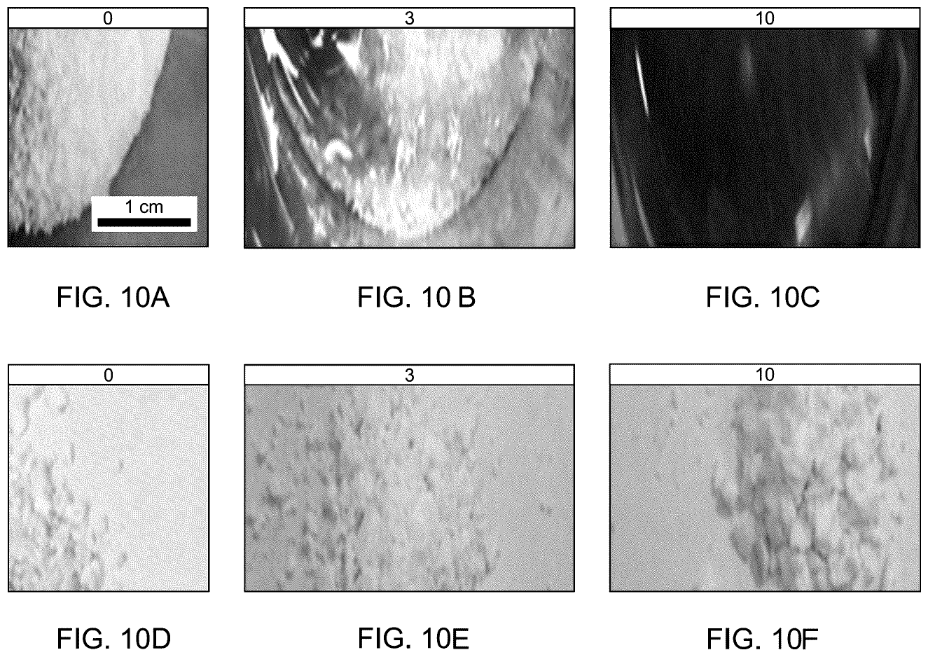

In order to assess the stability of the structure, the melting temperature of material was set marginally above that of PEG during the composite seepage tests of MgO-PEG. The mixture of pure PEG and MgO-PEG was heated to 80° C. for a plurality of duration, as shown in FIGS. 10A-10B. Pure PEG melted completely after being heated to 80° C. for at least 8 minutes, while the MgO-PEG composite remained in its original solid state as illustrated in FIGS. 10A-10B. There was no liquid loss from the composite sample during this period. As seen in FIG. 10B, the intake test further demonstrated that the MgO-PEG composite microstructure did not change during this procedure.

### Example 9: Solar-to-Thermal Energy Storage Efficiency

As can be seen from the enhanced optical properties of the PCM, MgO in the MgO/PEG PCM enabled simultaneous solar-to-thermal energy conversion and thermal energy storage. The MgO/PEG may assist PEG absorb more light throughout the entire visible spectrum, increasing the absorption at approximately 300 nm. The UV-vis absorption spectra of PEG alone and MgO/PEG PCM were compared for additional confirmation, and it was found that MgO had higher absorption than PEG alone. Based on the UV-vis absorption spectra in the visible range [Zhang, L. et. al., Applied Thermal Engineering, 101 (2016) 217-223, incorporated herein by reference in its entirety]. The solar-to-thermal energy storage efficiency of a PEG/graphene PCM was estimated using equation 5. The optical characteristics and high latent heat value of the material were responsible for the enhanced solar energy conversion into thermal energy and energy storage capacity of the PCM. Moreover, the light absorption spectra of MgO/PEG, recorded across the full visible spectrum, were wider than that of PEG alone. In order to evaluate the conversion of solar energy into thermal energy by PEG 6000 and MgO, temperature recorders were positioned beneath solar simulators. The increase in temperature was attributed to the high activity of MgO and/or PEG, which acted as a molecular stove and facilitated photon emission. Infrared light caused PEG to heat up under solar irradiation, reaching an optimal temperature after prolonged exposure, thereby demonstrating solar-to-thermal energy conversion through a phase change. During cooling, a distinct stage was observed, indicating the release of stored energy. Equation 5 is provided hereinafter, which may be used to calculate the solar to thermal energy storage efficiency.

$$η = m Δ H / IS ( {T}_{t} - {T}_{f} ) \qquad ( 5 )$$

In equation 5, “m” denoted the weight of the sample, and “ΔH” represented the enthalpy of the melting phase change. “I” and “S” referred to the optical power density and radiated field, respectively, while “Tₜ” and “T_{f}” correspond to the starting and ending phase transition times.

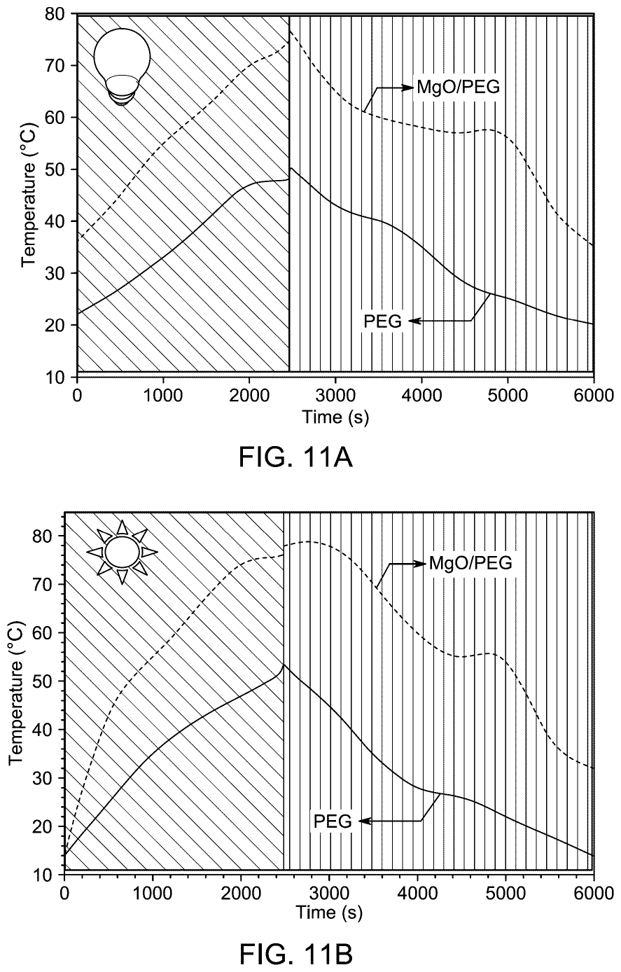

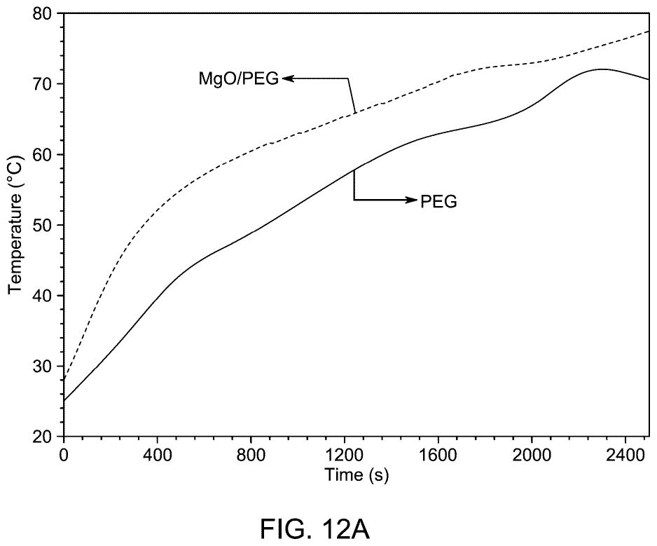

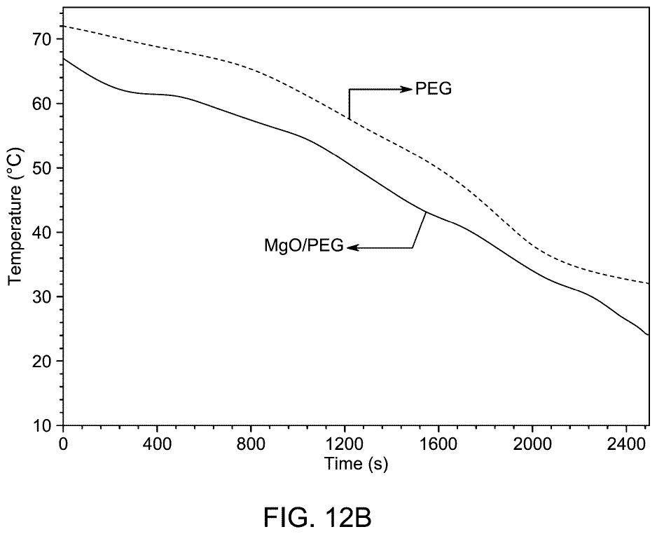

An optimal value was observed with prolonged radiation exposure, indicating the storage of thermal energy through a phase change. MgO/PEG PCM had a solar-to-thermal energy storage efficiency (f) of 80.2%. The results demonstrated good efficiency in photothermal energy storage compared to previously reported PCMs made of carbon-containing materials. In an example, a PCM based on wax impregnated with carbon nanotubes, exhibited a heat storage efficiency of approximately 40% to 60% [Qian, T., et. al., Energy, 82 (2015) 333-340, incorporated herein by reference in its entirety]. In order to evaluate the performance of the MgO/PEG PCM for practical applications, sunlight exposure was utilized. Prolonged solar radiation caused a temperature increase, with an optimal temperature boost observed, as shown in FIG. 11A. When sunlight was blocked during the cooling process, an optimal temperature reduction was achieved, as shown in FIG. 11B. Through phase transitions, the system effectively converted solar energy into heat energy and stored it. The high enthalpy of MgO indicated that the PCM possessed a substantial thermal capacity to meet real-world application requirements. Furthermore, the heating and cooling plateau temperatures aligned with the melting and freezing points in the solar-to-thermal energy conversion curves depicted in FIGS. 12A and 12B. The solar-to-heat conversion efficiency drops by less than 0.59% after 200 cycles.

The aspects of the present disclosure provide the solar energy device and the method of forming thereof. In particular, the enhanced accessibility and desirable polymer dispersion with controlled porosity of the MgO particles produced in the present disclosure may be advantageously used for PCM technology. The mesoporous structure of the MgO samples synthesized using PA exhibited a narrow pore size distribution, which is probably crucial in reducing the supercooling effect and lending a high latent heat value. A highly porous structure in range of 80% to 90%, good absorption capacity, and chemical inertness characterize the magnesium oxide prepared in the present disclosure, which may prevent the leakage of melted PEG. Moreover, the thermally conductive network of the MgO pore structure may assist in increasing the thermal conductivity of the composite.

Numerous modifications and variations of the present disclosure are possible in light of the above teachings. It is therefore to be understood that within the scope of the appended claims, the invention may be practiced otherwise than as specifically described herein.

1. A solar energy storage device, comprising
a porous support comprising nanosheets of MgO arranged to form spherical MgO microparticles; and
a phase change material, wherein
the phase change material is impregnated into the porous support;
the porous support has a bimodal pore distribution having a first mode in a region of 5 to 10 nm and a second mode in a region of 25 to 75 nm; and
the spherical MgO microparticles have a mean particle size of 2.5 to 10 μm and are formed from nanosheets of MgO having a mean thickness of 5 to 150 nm.

2. The solar energy storage device of claim 1, wherein the porous support has a surface area of 150 to 225 m²/g.

3. The solar energy storage device of claim 1, wherein the porous support has a pore volume of 0.50 to 0.65 cm³/g.

4. The energy storage device of claim 1, wherein the phase change material is an organic phase change material which is at least one selected from the group consisting of a polyether, a polyolefin, a polyamide, a polycarbonate, a polyester, a petroleum wax, an animal-derived wax, a plant-derived wax, a fatty acid or fatty acid ester, and a sugar alcohol.

5. The energy storage device of claim 4, wherein the phase change material comprises a polyether.

6. The solar energy storage device of claim 4, wherein the phase change material comprises a polyethylene glycol.

7. The energy storage device of claim 6, wherein the phase change material is polyethylene glycol having a mean molecular weight of 6000.

8. The energy storage device of claim 7, wherein the polyethylene glycol having a mean molecular weight of 6000 in the solar energy storage device has a melting temperature of 55 to 62.5° C.

9. The energy storage device of claim 1, wherein the solar energy storage device has a thermal conductivity of 0.10 to 2.10 Wm⁻¹K⁻¹.

10. The energy storage device of claim 1, wherein the solar energy storage device has a latent heat of melting of 150 to 189 J/g.

11. The energy storage device of claim 1, wherein the solar energy storage device has a latent heat of fusion of 110 to 140 J/g.

12. The energy storage device of claim 1, wherein the solar energy storage device has an energy storage efficiency of greater than 80%.

13. The energy storage device of claim 1, wherein the phase change material is present in an amount of 50 to 80 wt. % based on a total weight of the energy storage device.

14. A method of forming the energy storage device of claim 1, the method comprising
hydrothermally treating a magnesium source and a structure directing agent comprising an alpha hydroxy carboxylic acid in an aqueous ammonia solution having a pH of 8 to 11 to produce a magnesium hydroxide intermediate;
calcining the magnesium hydroxide intermediate at 400 to 600° C. for 1 to 4 hours to produce the porous support; and
impregnating the support with the phase change material.

15. The method of claim 14, wherein the alpha hydroxy carboxylic acid is an aromatic alpha hydroxy carboxylic acid.

16. The method of claim 15, wherein the aromatic alpha hydroxy carboxylic acid is pamoic acid.

17. The method of claim 14, wherein the magnesium source is magnesium nitrate.

18. The method of claim 14, wherein the magnesium hydroxide intermediate comprises nanosheets of magnesium hydroxide arranged to form flower-like microparticles.

19. The method of claim 14, wherein the impregnating is performed by mixing the porous support with a solution comprising the phase change material and an organic solvent to form an impregnation mixture, and
drying the impregnation mixture to form the energy storage device.

20. The method of claim 19, wherein the drying comprises heating the impregnation mixture to 60 to 100° C. for 12 to 36 hours.
